(19) United States
(12) Patent Application Publication
(10) Pub. No.: US 2010/0180186 A1
(43) Pub. Date: Jul. 15, 2010

(54) System and Method for Storage and Distribution of Electronic Publications by Content Creators and Online Publishers with Referral-Based Commissions

(76) Inventors: James Skinner, Singapore (SG); Michael Hewitt, South Jordan, UT (US); Douglas Weber, Salt Lake City, UT (US); Gilbert Reimschussel, Salt Lake City, UT (US); D. Christian Harrisson, Salt Lake City, UT (US); Steve Conlee, Pleasant Grove, UT (US); Eugene Skinner, Musashino-shi (JP)

Correspondence Address: KIRTON AND MCCONKIE, 60 EAST SOUTH TEMPLE,, SUITE 1800, SALT LAKE CITY, UT, 84111, US

(21) Appl. No.: 12/559,245

(22) Filed: Sep. 14, 2009

Related U.S. Application Data
(60) Provisional application No. 61/097,533, filed on Sep. 16, 2008.

(51) Int. Cl. G06Q 30/00; G06F 17/00; G06F 3/048; G06Q 50/00; G06Q 10/00; G06F 15/16

(52) U.S. Cl. 715/205; 715/862; 705/14.16; 705/14.13; 709/206

(57) ABSTRACT

A method for storage and distribution of electronic publications by content creators and online publishers with referral-based commissions utilizes a repository of products and an associated delivery system. An invitor registers with the system and provides referral addresses to the system, which sends an electronic invitation to use the system to the addresses. The recipients can use the system to purchase electronic publication products and/or to sell their own electronic publication products. Commissions are provided to the invitor based on purchases by the recipients of the invitations and/or based on sales of products on the system by recipients of the invitations.

### CROSS-REFERENCE TO RELATED APPLICATIONS

This application claims the benefit of U.S. Provisional Application No. 61/097,533, filed Sep. 16, 2008.

### BACKGROUND OF THE INVENTION

1. Field of the Invention

The present invention relates to distribution of electronic publications over a network, and more particularly to systems and methods for storage and distribution of such publications with referral-based commissions.

2. Background and Related Art

Networks such as the Internet have provided new forms of communication previously unknown. These forms of communication have provided opportunities to distribute content in new ways that were previously unavailable. For example, files and documents of all types, including audio files, video files, textual files, program files, and the like can now be distributed around the world virtually on-demand to almost any network-connected computer or device.

### BRIEF SUMMARY OF THE INVENTION

One implementation of the invention provides a method for storage and distribution of electronic publications by content creators and online publishers with referral-based commissions. The method utilizes a repository of products for delivery over a network and an associated delivery system. In the method, the system receives a set of one or more referral addresses from an invitor and sends an electronic invitation to the set of referral addresses provided by the invitor, the invitation including a) a link identifying one of the invitor and the electronic invitation and b) at least one of an invitation to view and purchase a product from the repository of products and an invitation to sell a product using the repository of products.

The system then may receive, from a recipient of the invitation, a purchase of a product from the repository of products after utilization by the recipient of the link, whereupon the system utilizes information provided by the user of the link to apply one of a commission and a credit to the invitor for the invitee's purchase. Alternatively or additionally, the system may receive, from the recipient, a registration of the recipient as a seller of products after utilization by the recipient of the link. When a sale of a product provided by the recipient to the repository of products occurs, the system utilizes information provided by the use of the link to apply one of a commission and a credit to the invitor for the sale of the recipient's product.

The products in the repository may include one or more computer files or other electronic publications that can be delivered over a network, including program files. When the system receives selection of the link in the electronic invitation (such as an e-mail) from the recipient, the system provides a web page associated with the link according to the nature of the invitation, such as a web page including one of information about a product from the repository of products and information regarding services provided in association with the repository of products.

According to a second implementation of the invention, a method for storage and distribution of electronic publications by content creators and online publishers with referral-based commissions is provided. The method also utilizes a repository of products for delivery over a network and an associated delivery system. In this method, the system receives a set of one or more referral addresses from an invitor and sends an electronic invitation (e.g. e-mail invitation) to the set of referral addresses provided by the invitor. The invitation includes an identifying link along with an invitation to a recipient to use the system to sell the recipient's products using the system. When the recipient registers as a seller of products, the system associates the registration of the recipient with the invitor.

The system receives an upload of a recipient product into the repository of products from the recipient and makes the recipient product available for sale. The system receives a request to purchase the recipient product and payment for the request and utilzes the association of the recipient and the invitor to provide one of a commission and a credit to the invitor for the purchase of the recipient product.

According to a third implementation of the invention, a method for storage and distribution of electronic publications by content creators and online publishers with referral-based commissions is provided in association with a system for storage and distribution of electronic publications from a repository of products over a network. The system receives a first registration of a user of the system and provides an identifier for the registered user. The system then receives a set of one or more referral e-mail addresses from the registered user, wherein the registered user becomes an invitor. Each e-mail address is associated with an invitee being invited to use the system by the invitor.

The system sends an electronic invitation to the set of referral e-mail addresses provided by the invitor, the invitation being for the invitees to use the system. The system receives a second registration, this registration being of one of the invitees to use the system. Upon receiving the second registration, the system identifies the invitor and associates a user record of the invitee with a user record of the invitor. The system may use any method to identify the invitor when the invitee registers. For example, the system may associate the invitor and invitee based on an invitee e-mail address used for registration of the invitee that matches the address provided by the invitor. As another example, the system may associate the invitor and invitee using a link provided in the electronic invitation and used by the invitee to access the system. Alternatively, the system may associate the invitor and invitee based on an input of the invitor's identifier or some other information input by the invitee upon registration.

The system receives a sale of a product from the repository of products, which sale is associated with the invitee and applies a commission or credit to the invitor for the sale of the product. The sale of the product may include a direction from the invitee to purchase the product from the repository of products. Alternatively or additionally, the sale of the product may include a direction from a third party to purchase the product from the repository of products, where the product is a product uploaded to the repository of products by the invitee.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer environment for use with embodiments of the invention;

FIG. 2 shows a representative network environment for use with embodiments of the invention;

FIGS. 3-32 show representative screen shots illustrating functions of a representative network-based system for distribution of files;

FIG. 33 illustrates representative processes for providing a list view of search results to a user of a network-based system for distribution of files;

FIG. 34 illustrates a further representative network environment for use with embodiments of the invention;

FIG. 35 illustrates a process according to one embodiment of the invention;

FIG. 36 illustrates a process according to another embodiment of the invention;

FIG. 37 illustrates a process according to another embodiment of the invention;

FIG. 38 shows a representative screen shot of a referral input screen;

FIG. 39 shows a representative screen shot of an alternative referral input screen;

FIG. 40 shows an example referral invitation;

FIG. 41 shows a representative screen shot of a web page shown upon using a link from a referral invitation;

FIG. 42 shows a representative screen shot of a display that may be provided to allow a user to sign up with a distribution system; and

FIGS. 43-44 show illustrative reports showing commissions generated using embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

One embodiment of the invention provides a method for storage and distribution of electronic publications by content creators and online publishers with referral-based commissions. The method utilizes a repository of products for delivery over a network and an associated delivery system. In the method, the system receives a set of one or more referral addresses from an invitor and sends an electronic invitation to the set of referral addresses provided by the invitor, the invitation including a) a link identifying one of the invitor and the electronic invitation and b) at least one of an invitation to view and purchase a product from the repository of products and an invitation to sell a product using the repository of products.

The system then may receive, from a recipient of the invitation, a purchase of a product from the repository of products after utilization by the recipient of the link, whereupon the system utilizes information provided by the user of the link to apply one of a commission and a credit to the invitor for the invitee's purchase. Alternatively or additionally, the system may receive, from the recipient, a registration of the recipient as a seller of products after utilization by the recipient of the link. When a sale of a product provided by the recipient to the repository of products occurs, the system utilizes information provided by the use of the link to apply one of a commission and a credit to the invitor for the sale of the recipient's product.

The products in the repository may include one or more computer files or other electronic publications that can be delivered over a network, including program files. When the system receives selection of the link in the electronic invitation (such as an e-mail) from the recipient, the system provides a web page associated with the link according to the nature of the invitation, such as a web page including one of information about a product from the repository of products and information regarding services provided in association with the repository of products.

According to a second embodiment of the invention, a method for storage and distribution of electronic publications by content creators and online publishers with referral-based commissions is provided. The method also utilizes a repository of products for delivery over a network and an associated delivery system. In this method, the system receives a set of one or more referral addresses from an invitor and sends an electronic invitation (e.g. e-mail invitation) to the set of referral addresses provided by the invitor. The invitation includes an identifying link along with an invitation to a recipient to use the system to sell the recipient's products using the system. When the recipient registers as a seller of products, the system associates the registration of the recipient with the invitor.

The system receives an upload of a recipient product into the repository of products from the recipient and makes the recipient product available for sale. The system receives a request to purchase the recipient product and payment for the request and utilzes the association of the recipient and the invitor to provide one of a commission and a credit to the invitor for the purchase of the recipient product.

According to a third embodiment of the invention, a method for storage and distribution of electronic publications by content creators and online publishers with referral-based commissions is provided in association with a system for storage and distribution of electronic publications from a repository of products over a network. The system receives a first registration of a user of the system and provides an identifier for the registered user. The system then receives a set of one or more referral e-mail addresses from the registered user, wherein the registered user becomes an invitor. Each e-mail address is associated with an invitee being invited to use the system by the invitor.

The system sends an electronic invitation to the set of referral e-mail addresses provided by the invitor, the invitation being for the invitees to use the system. The system receives a second registration, this registration being of one of the invitees to use the system. Upon receiving the second registration, the system identifies the invitor and associates a user record of the invitee with a user record of the invitor. The system may use any method to identify the invitor when the invitee registers. For example, the system may associate the invitor and invitee based on an invitee e-mail address used for registration of the invitee that matches the address provided by the invitor. As another example, the system may associate the invitor and invitee using a link provided in the electronic invitation and used by the invitee to access the system. Alternatively, the system may associate the invitor and invitee based on an input of the invitor's identifier or some other information input by the invitee upon registration.

The system receives a sale of a product from the repository of products, which sale is associated with the invitee and applies a commission or credit to the invitor for the sale of the product. The sale of the product may include a direction from the invitee to purchase the product from the repository of products. Alternatively or additionally, the sale of the product may include a direction from a third party to purchase the product from the repository of products, where the product is a product uploaded to the repository of products by the invitee.

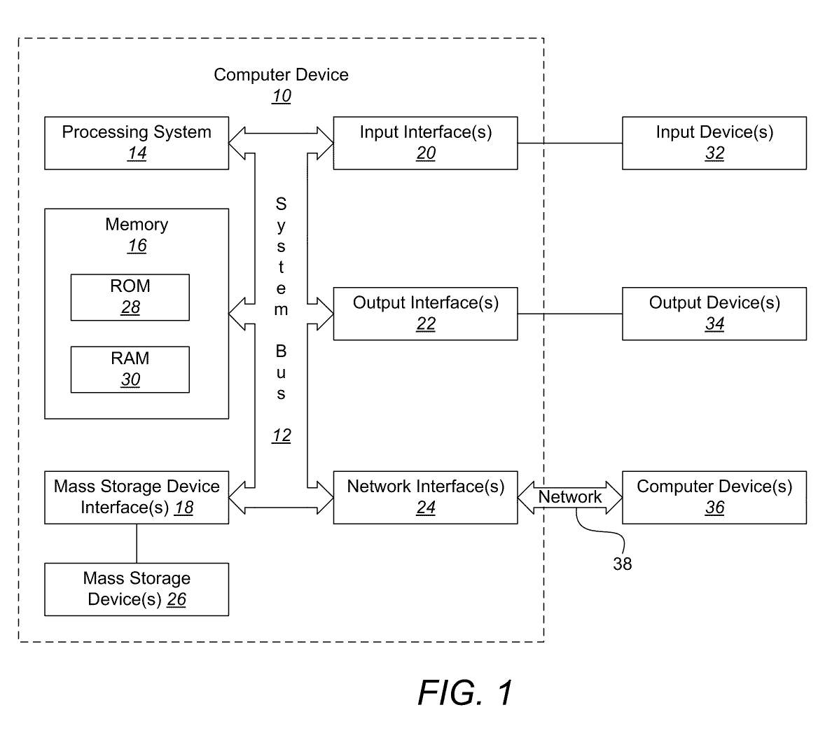

As embodiments of the invention are intended for use in with a variety of computer and electronic devices and systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more non-transitory, tangible computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium, albeit a transitory, non-tangible computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

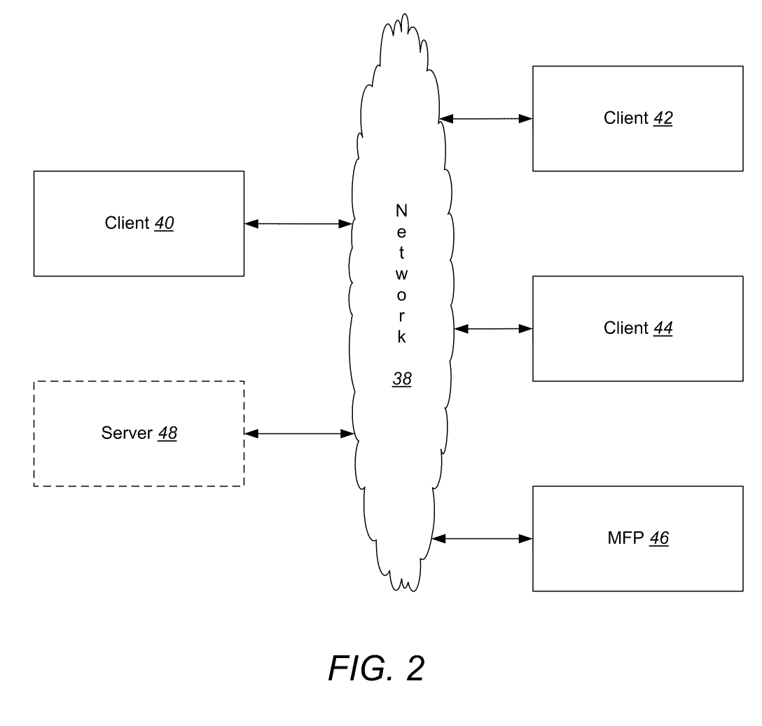

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

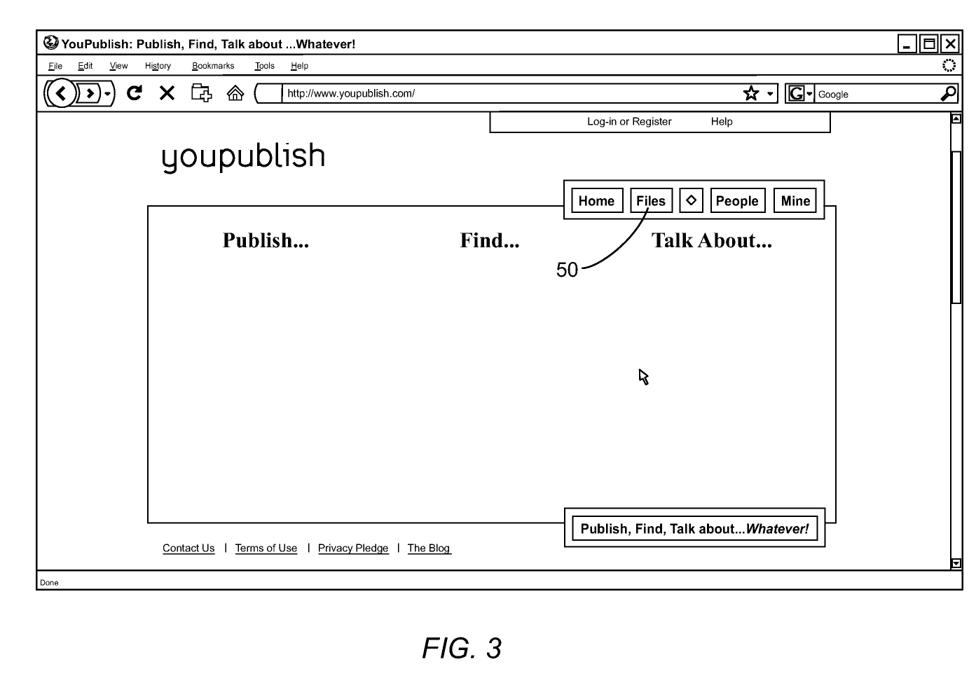

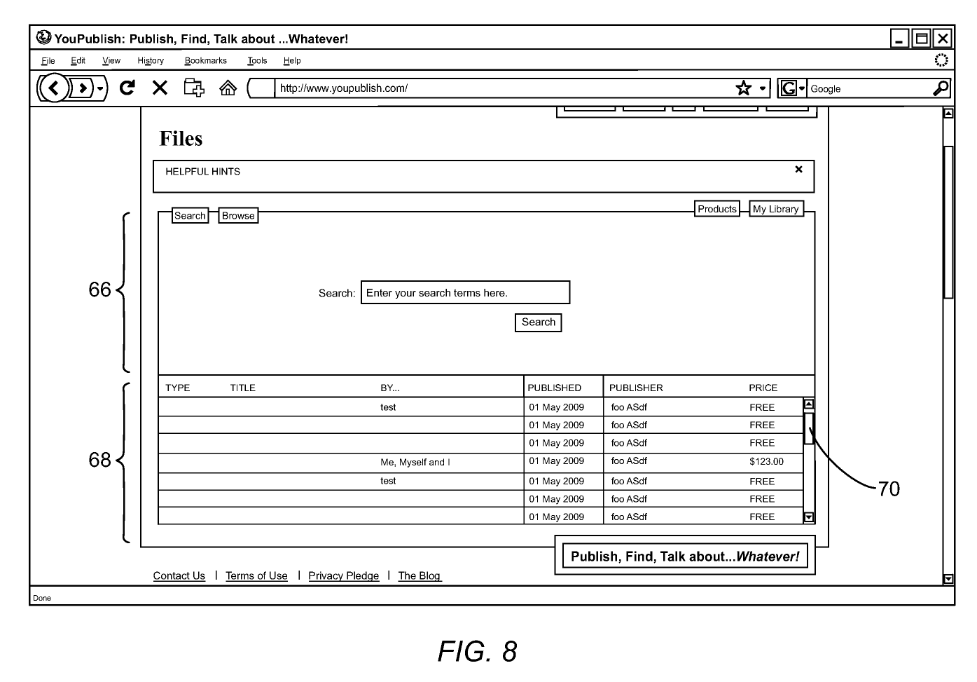

For the purpose of providing additional context, a base generic system platform and the use thereof will now be described in connection with FIGS. 3-33. The system permits creator-based electronic product distribution, including products not necessarily provided by the operator of the platform and its service but rather by independent content creators including but not restricted to authors, creators of files, creators of works, distributors of files and works, and online publishers (hereinafter “content creators”).

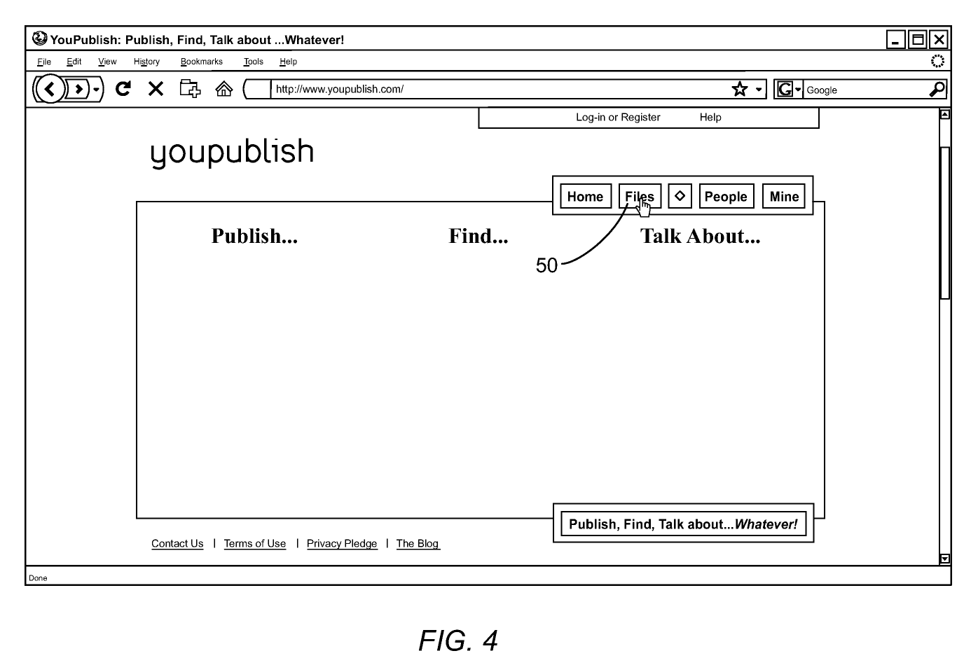

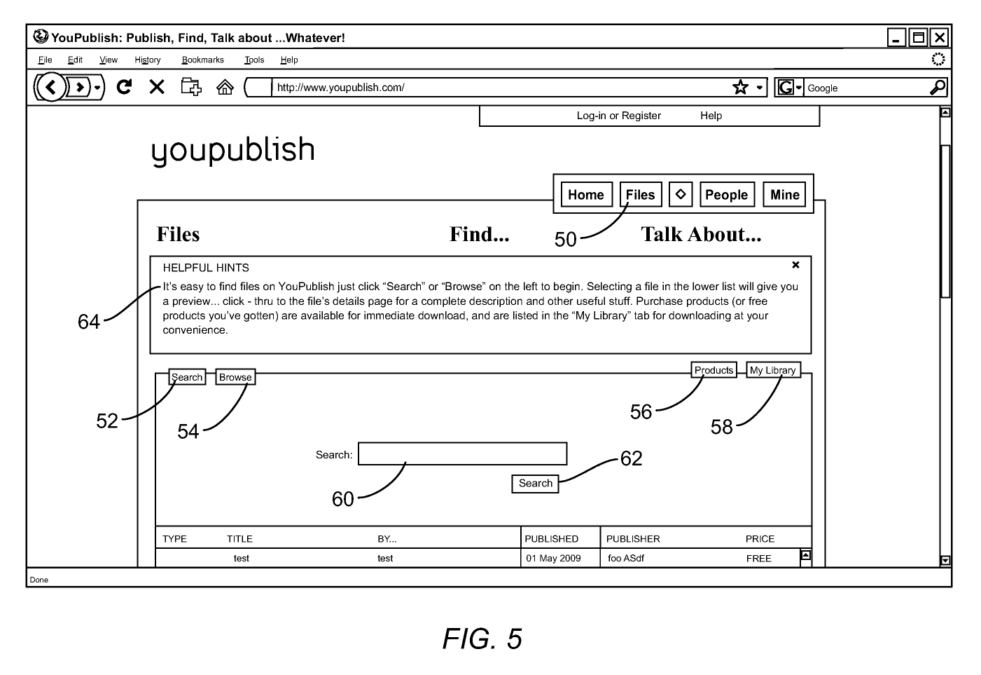

First, a user directs a web browser to a page providing the functionality described herein, as depicted in FIG. 3. In the example, a user clicks on a “files” button 50 as shown in FIG. 4 to select a file to download. That action presents a “Files” page as shown in FIG. 5. In that page, a user is presented with various tabs or buttons, including a search tab 52, a browse tab 54, a products tab 56 and a my library tab 58 within the files/search window shown. That search window includes a text area 60 to enter a search query, and a search button 62 to transmit a search query to a server over HTTP. The example presented herein includes a facility for purchasing copies of files, as will become apparent from the discussion below.

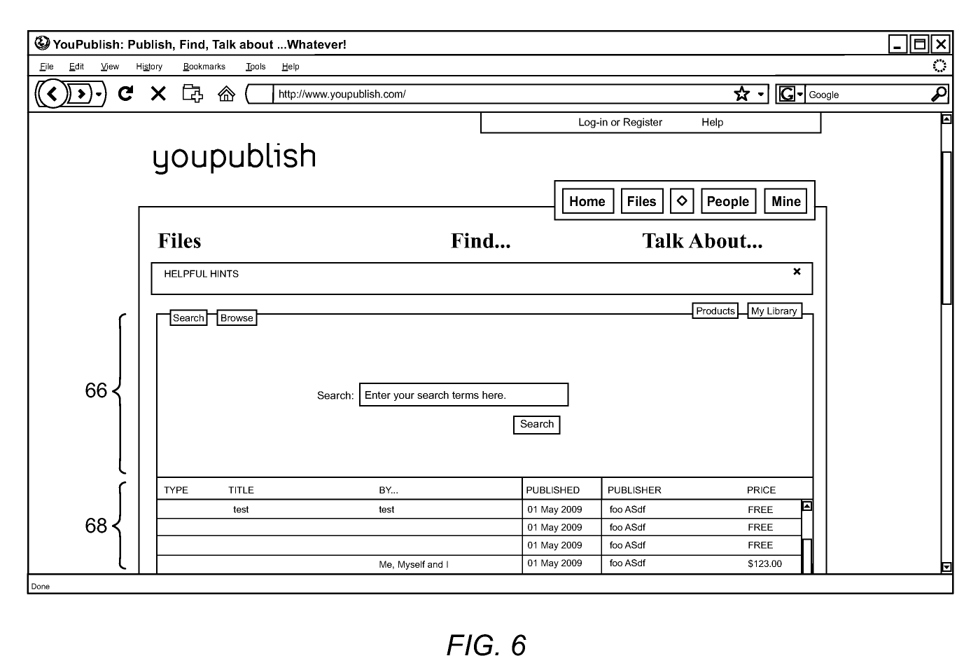

Now turning to FIG. 6, the “helpful hints” text 64 shown in FIG. 5 has been minimized to allow for greater real estate in the presentation of other elements. The window is partitioned into a search area 66 and a list presentation area 68 displaying files available for download and/or purchase, which may include results of a search for such files. In the example, portions of the presentation are rendered through code executed at the client device. This includes the list presentation area 68, described below.

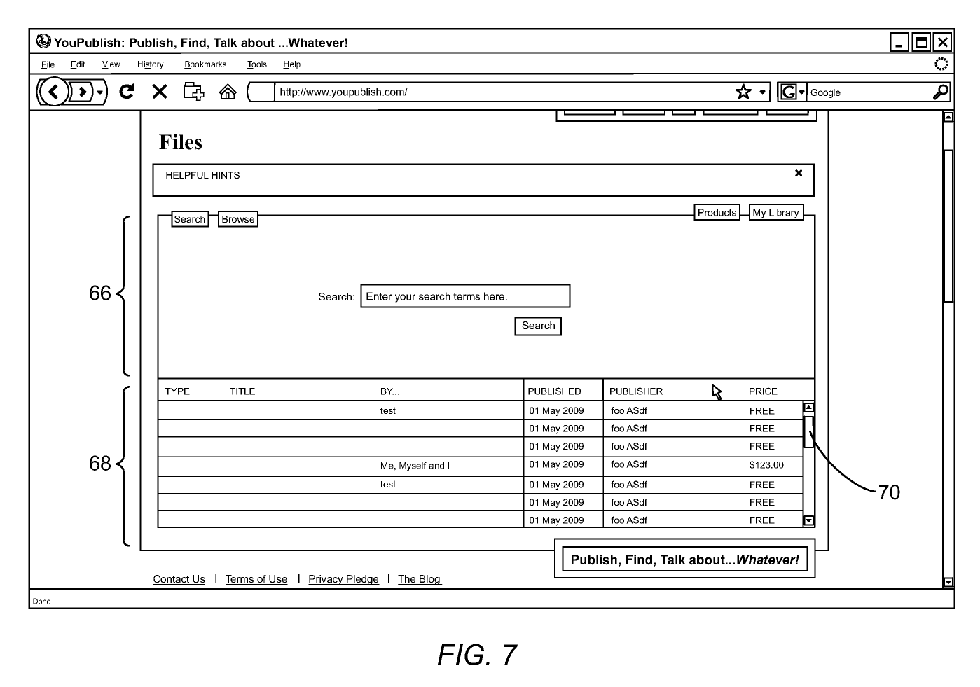

As shown in FIGS. 7, 8, and 9 the search area 66 and the list presentation area 68 may be adjustable with respect to position and size. These adjustments may be made through the locally-executed code, and may require no communication with a server. The list presentation area 68 is initially populated with items, using information retrieved from the server at the time the list presentation area 68 is initially rendered. This is performed through a request for an initial list to the server, which may or may not include a number of elements to retrieve.

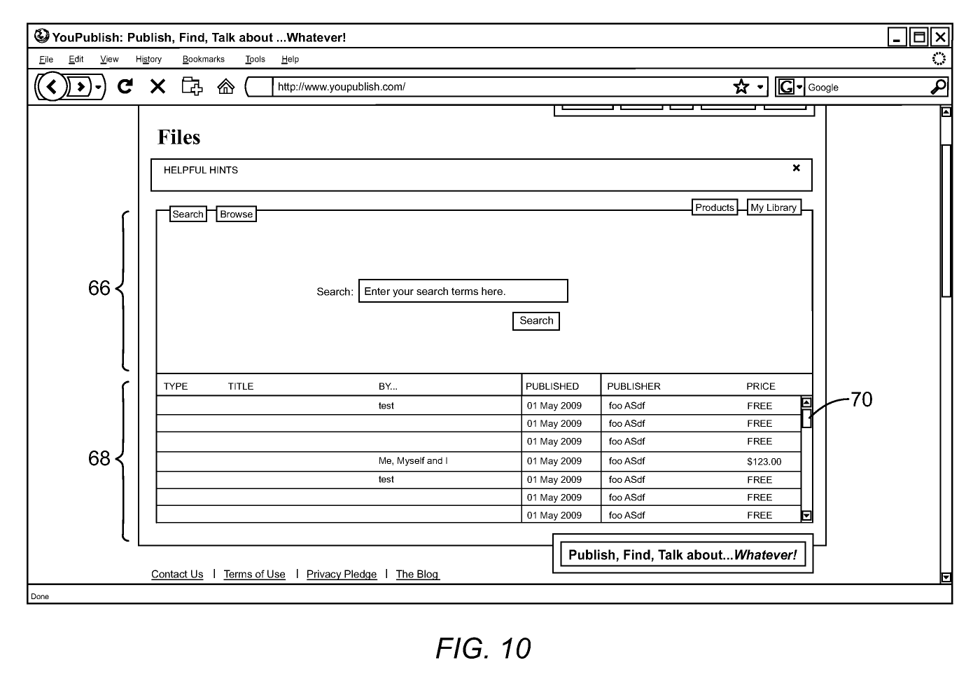

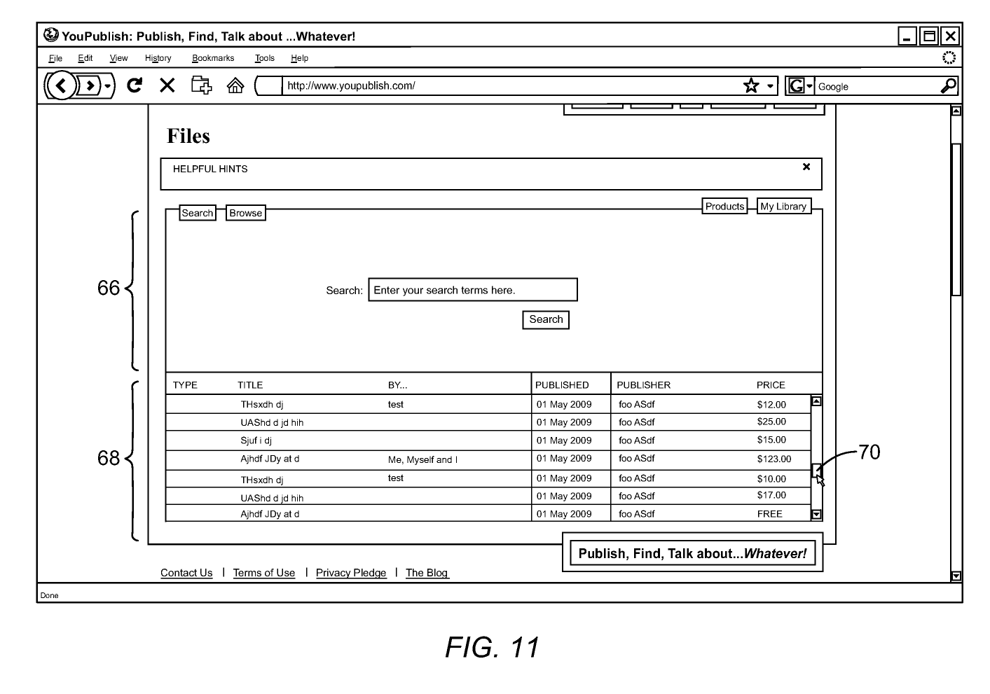

Continuing to FIG. 10, the list presentation area 68, when populated, may include a scroll bar 70 for scrolling through the list of items to be identified and/or made available for download. As the scroll bar 70 is dragged down (to see items not yet visible below) local code updates the view presented in the list presentation area 68. If the user continues to scroll down, now looking at FIG. 11, eventually he may run out of list items. This may be because not all of the items available on the server were transmitted to the client browser, but rather only a selected number. Limiting the number of items may serve to conserve bandwidth and/or server resources, especially where a user is likely to find what he is looking for in the first group of items presented. As the list is scrolled down to the bottom, the locally-executed code notes that additional list items are needed to continue a user's desire to continue to scroll down. In the example, this is through a trigger position of the scroll slider with respect to the bottom of the scroll bar, which may be by a fixed amount, an amount relative to the size of the scroll bar 70, or some other method.

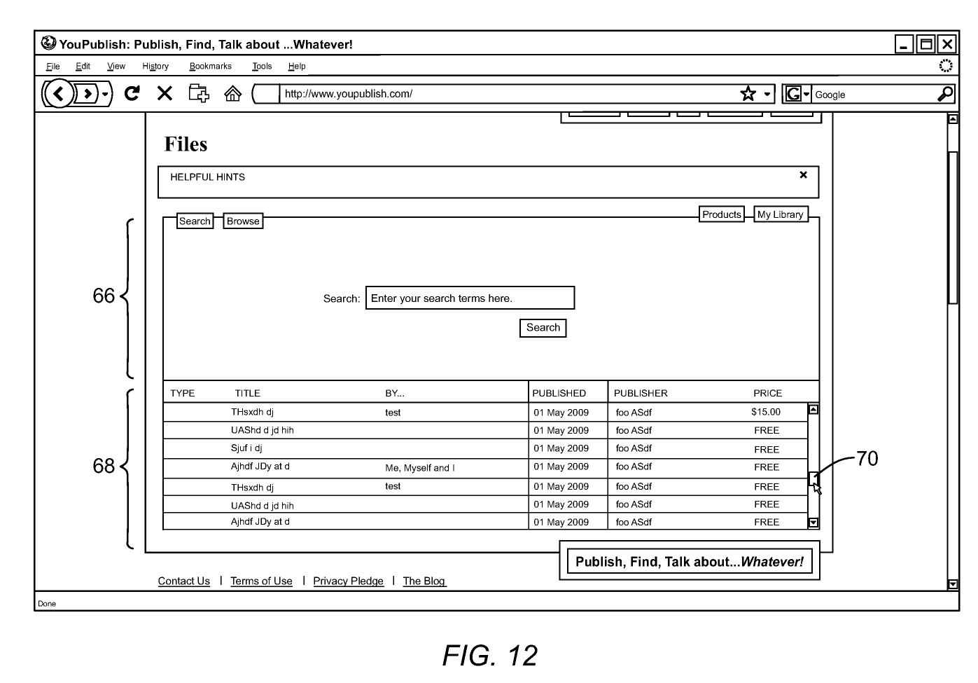

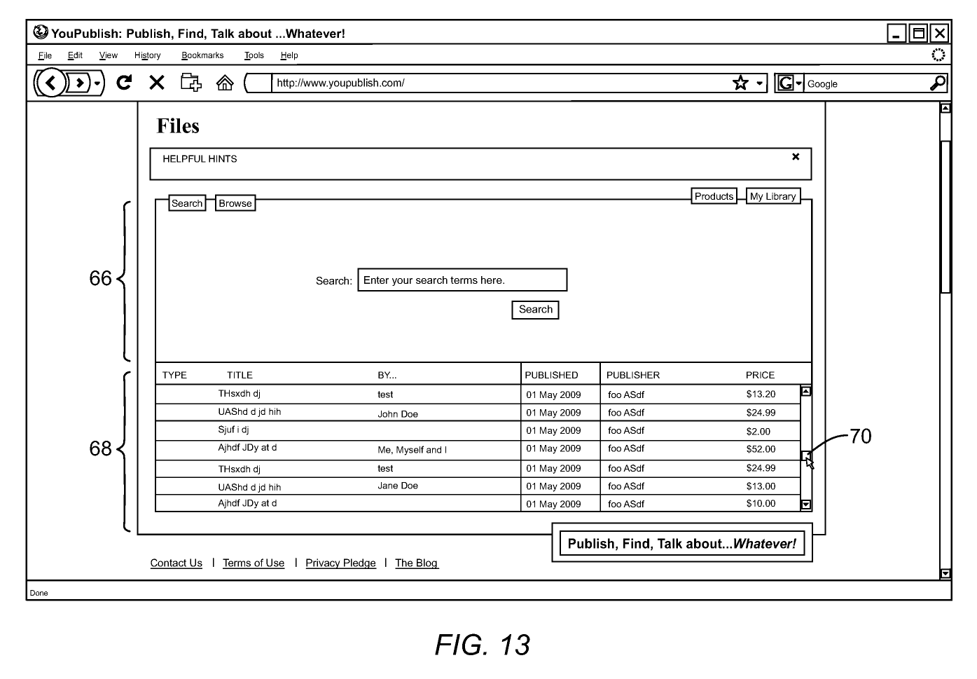

Upon receipt of additional list items, the size of the list of the list presentation area 68 increases and, accordingly, the slider in the scroll bar 70 is relocated as shown in FIG. 12. The user may then continue to scroll down as shown in FIG. 13. If the threshold is again exceeded the client-executed code may again request more list items, until there are no more to download or local resources are exhausted.

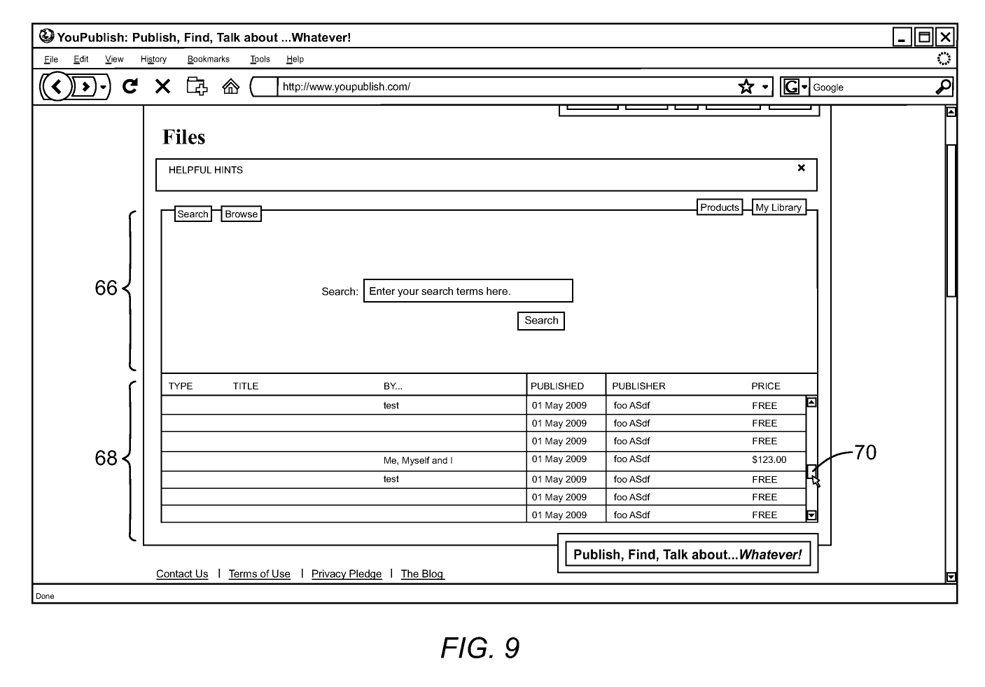

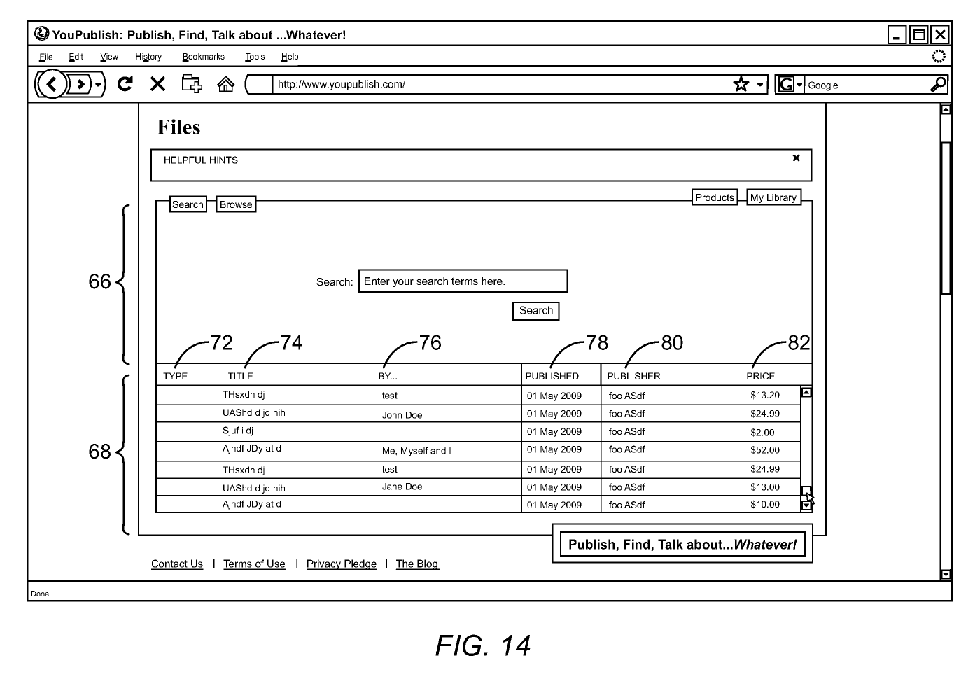

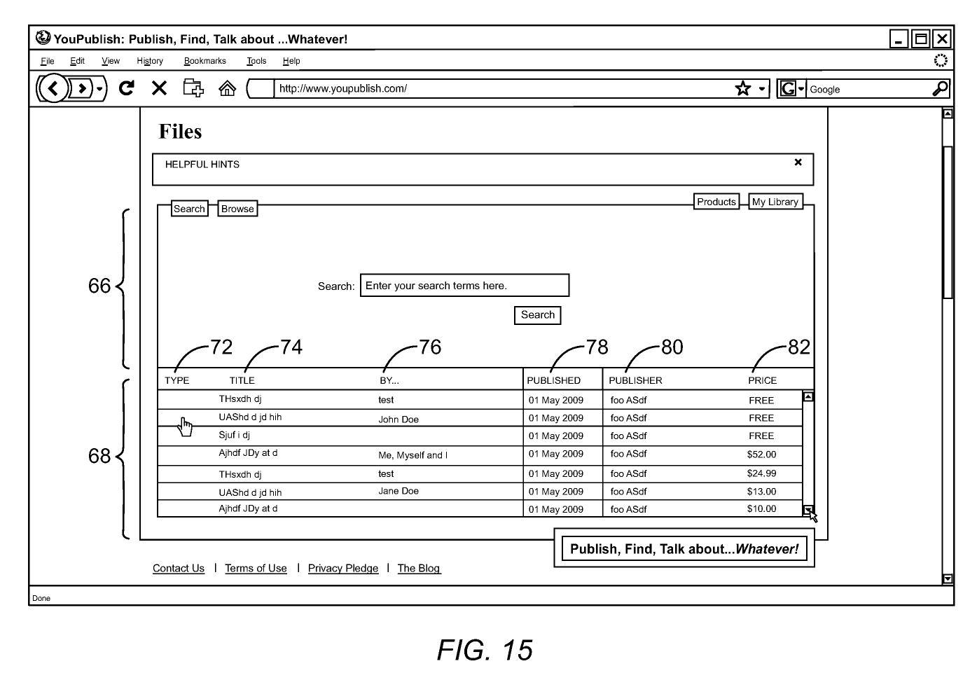

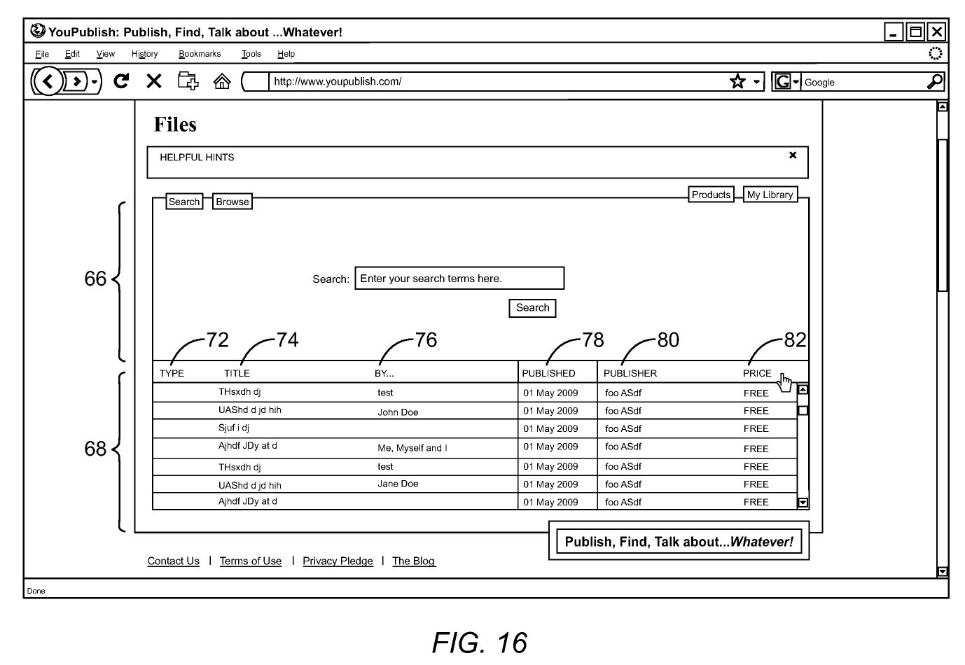

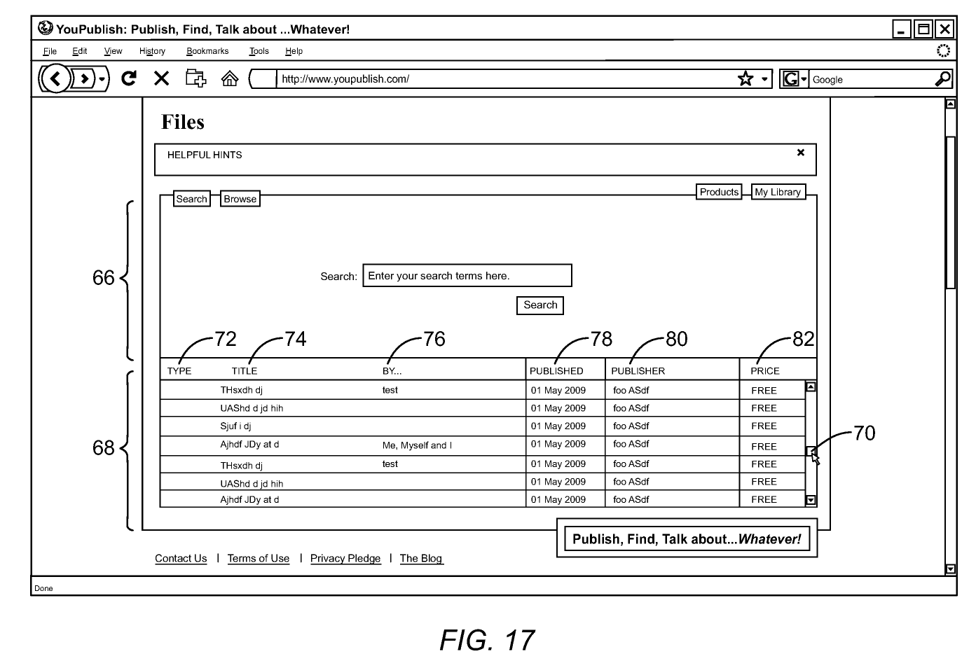

Now on FIG. 14, also in the presentation list displayed in the list presentation area 68 are headers indicating various features associated with each file of the list. In the illustrated example, the list presentation area 68 displays a type header 72 indicative of a type of the files in the list, a title header 74 indicative of a title of each of the files, a by header 76 indicative of authorship of the files, a published header 78 indicating a date of publishing/uploading of the files, a publisher header 80 indicative of a publisher of the files, and a price header 82 indicative of the price of each of the files. In the illustrated example, further information may be made available through placing or hovering a cursor over an icon or field, as depicted in FIG. 15, where a file might be shown as being of a particular type, such as “study-course.” By clicking on any of the headers 72-82, the list may be resorted according to these header criteria, as shown in FIGS. 9 and 16 by price, and FIGS. 10-15 by published date. The user may scroll down in the resorted list (using the scroll bar 70), as shown on FIG. 17.

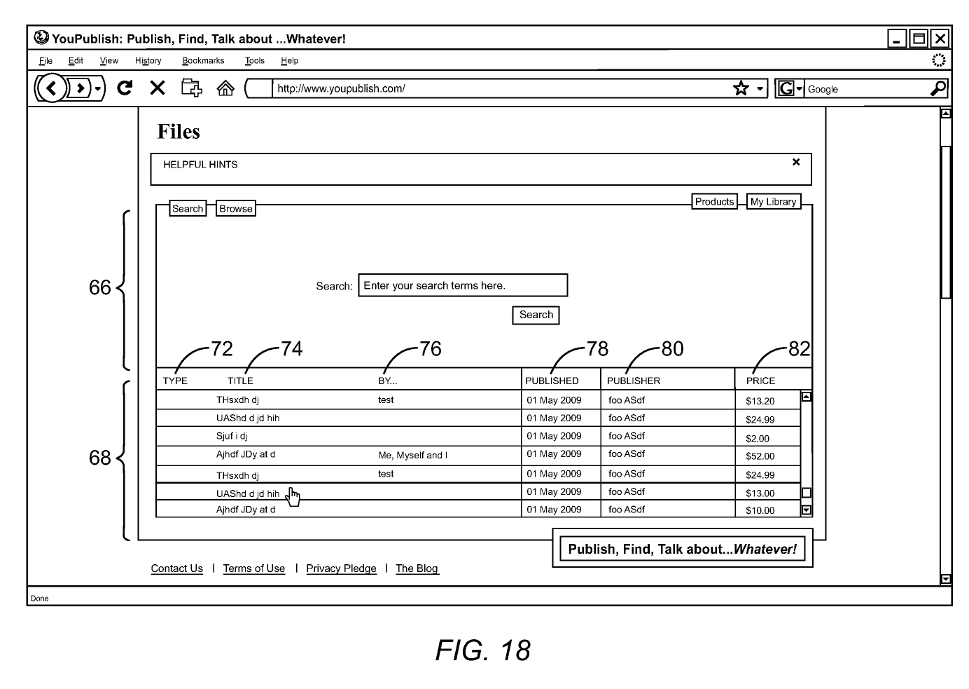

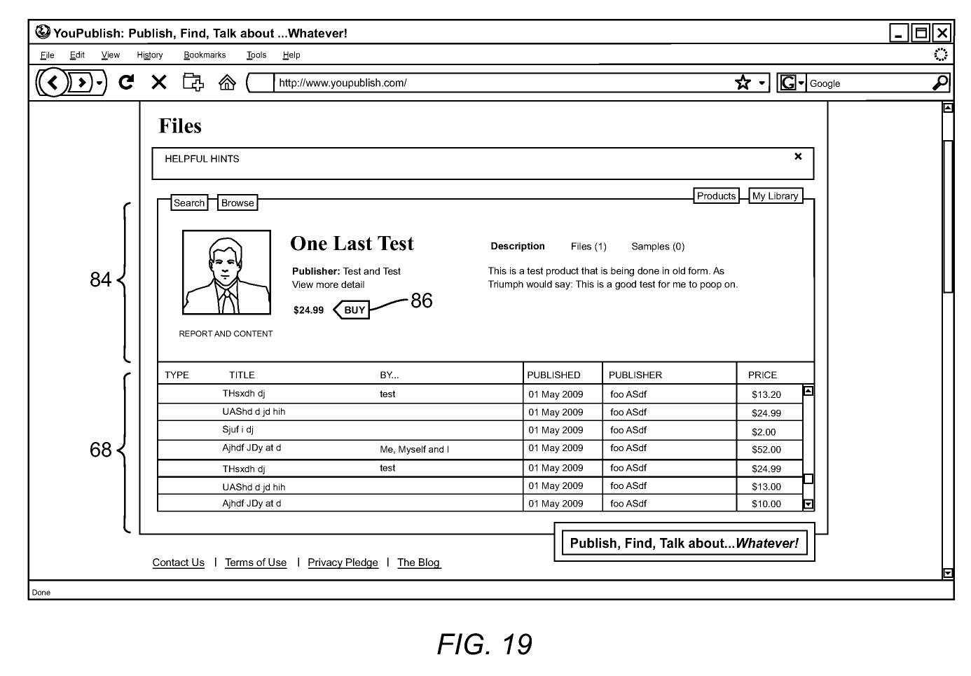

One item in the list (as scrolled and sorted) may be selected in the browser window as shown on FIG. 18. This may result in the locally executed code making a request to the server for further information. This further information may then be displayed as in the example of FIG. 19, showing an image, publishing information, description, number of files, price, title, and other information associated with the selected item in an information detail area 84.

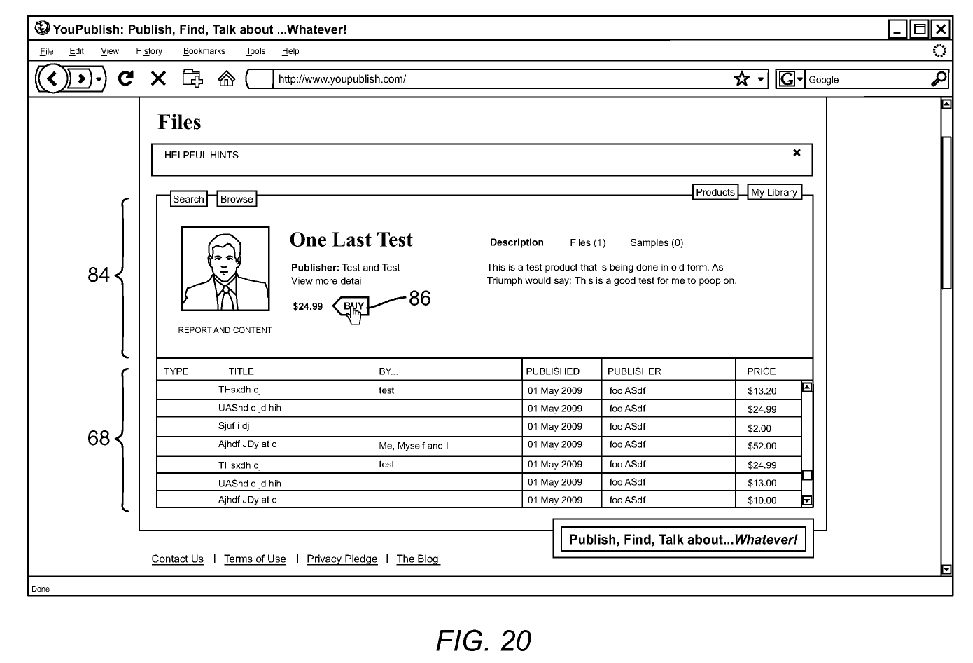

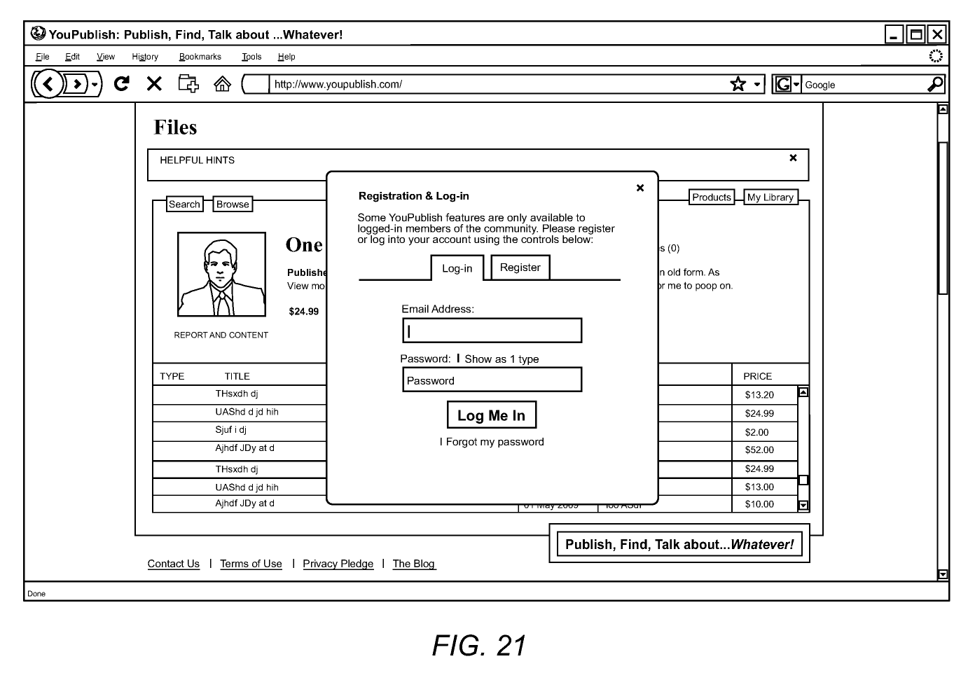

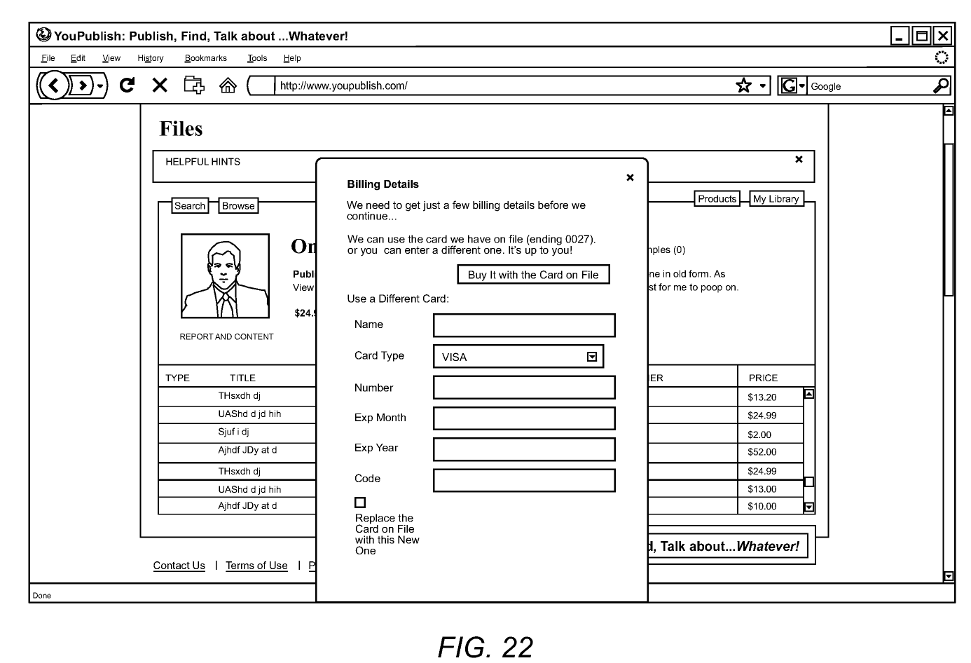

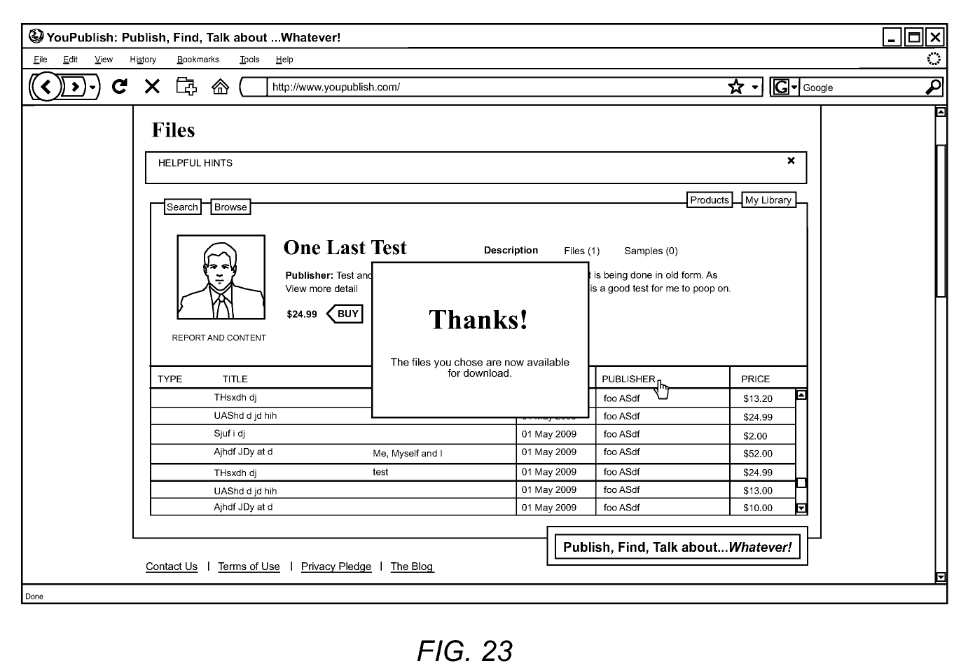

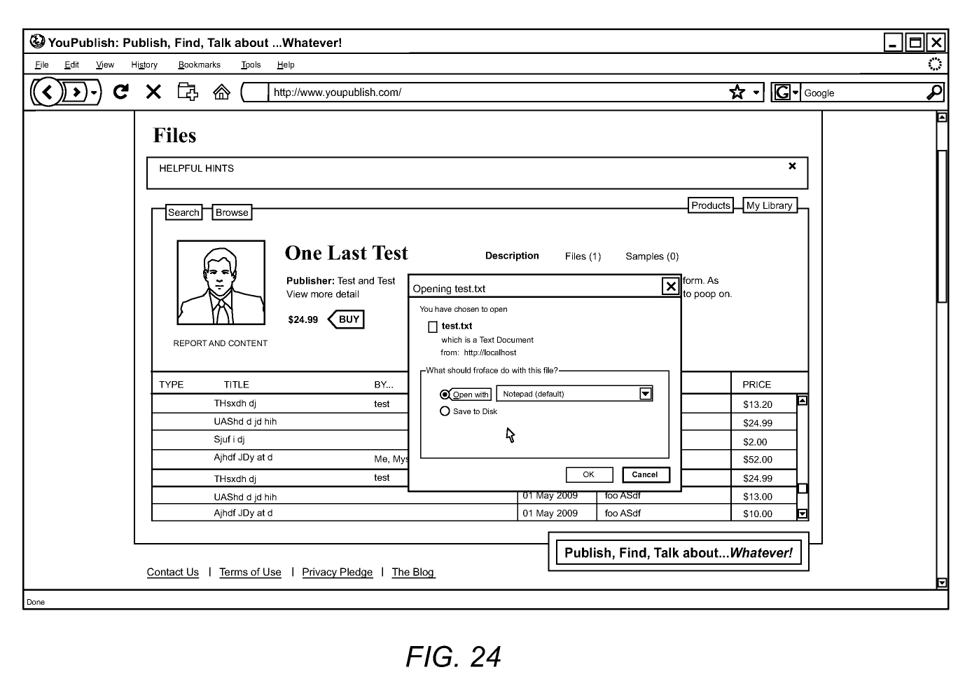

If the item is desirable to the user, he may click on a buy button 86, as shown in FIG. 20. In the example, that item in the list is then rendered in a dark background showing that it has been purchased. Upon selection of the buy button 86 or utilizing some other user purchase option, the client may need to be authenticated to a server for the transaction, such as through an e-mail address and password combination in a log-in pop-up as shown in FIG. 21. As shown in FIG. 22, information relative to the specific transaction may also be needed and provided by the user, which might be or include credit card information. Upon entry of a valid e-mail address and password and user transaction information, an acknowledgment may be generated as shown in FIG. 23. Locally-executed code may cause a download to commence automatically, or a download may be made available at a time of a user's choice, which may be saved in accordance with a user's specifications as depicted in FIG. 24.

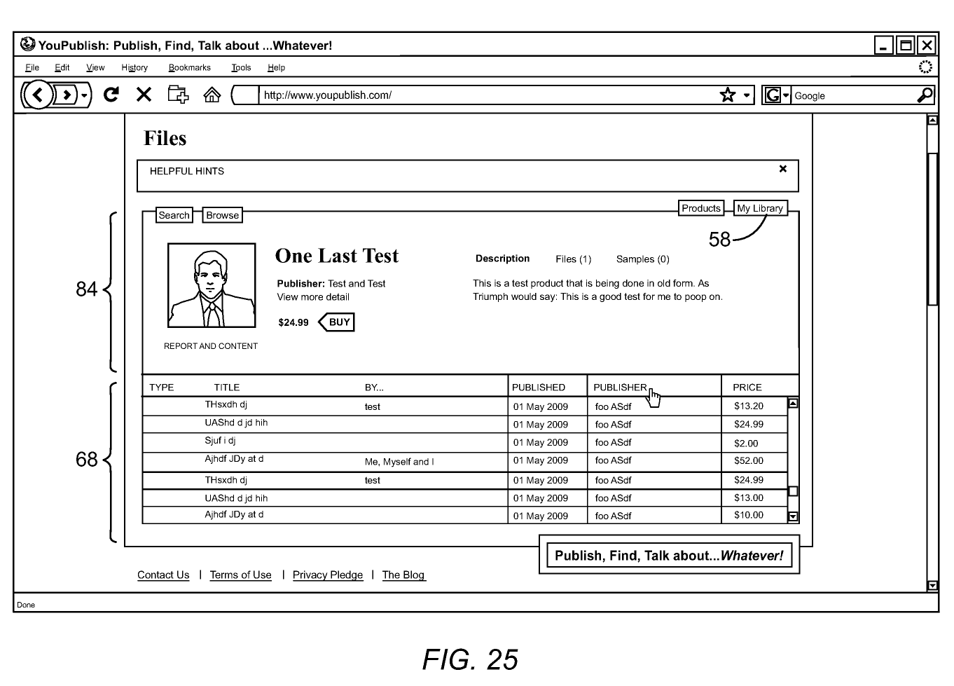

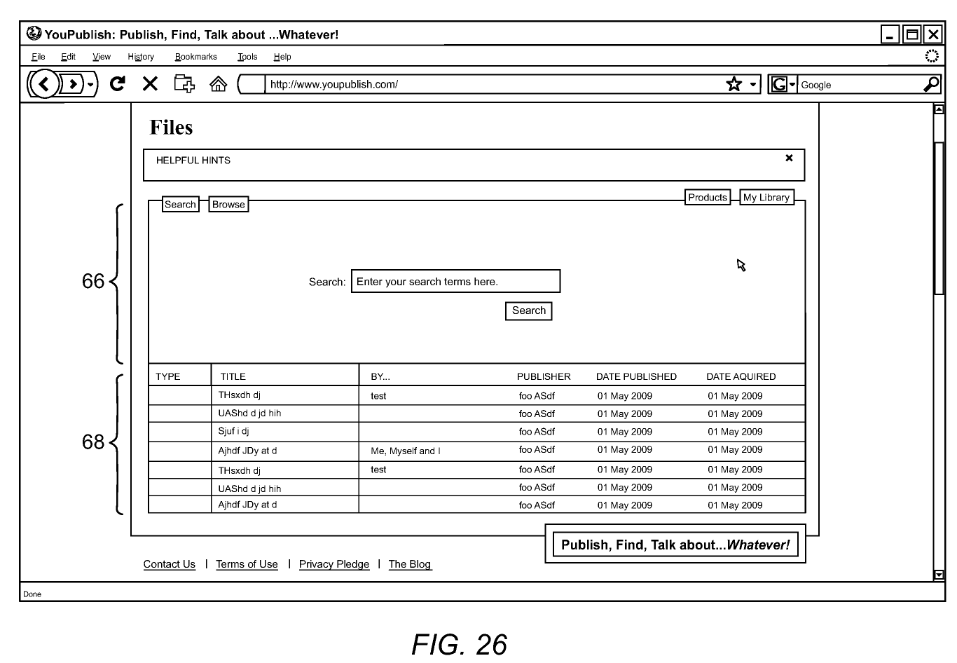

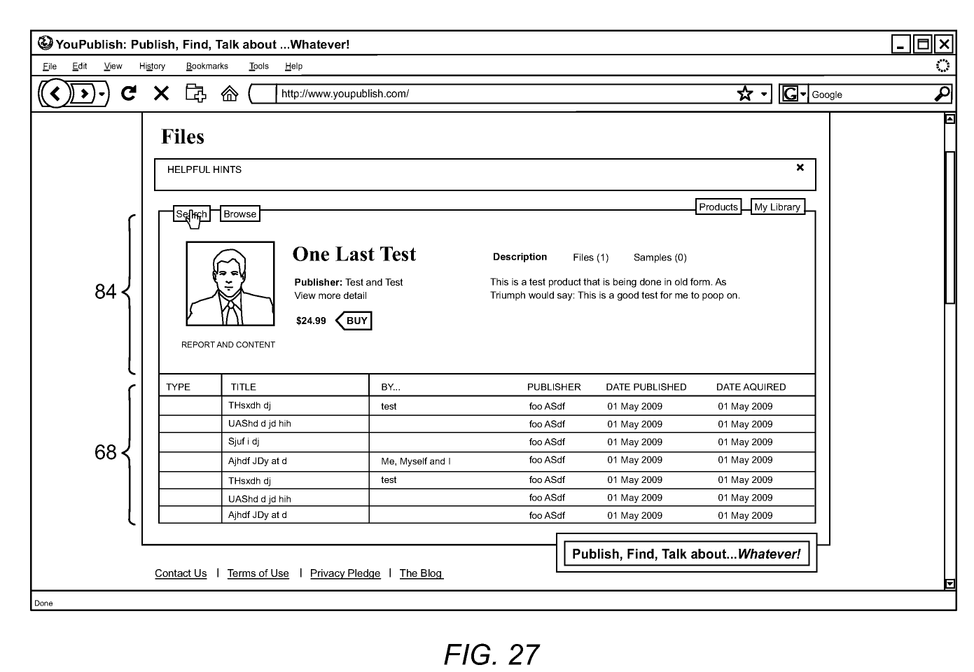

After purchase by a user, it may be desirable to download a file at a later time. A user may click on the my library tab 58, described above and shown in FIG. 25. A list may then be displayed like that shown in FIGS. 26 and 27, listing the files that have been purchased in the list presentation area 68, and possibly the search area 66 or the information detail area 84, which in the example operates similarly in the search and browse tab modes allowing for selection and viewing of further information, and other functionality described above. These files may then be downloaded by the user, which the server allows, it having a record that the currently-authenticated user has paid and/or is entitled to download the respective file or files.

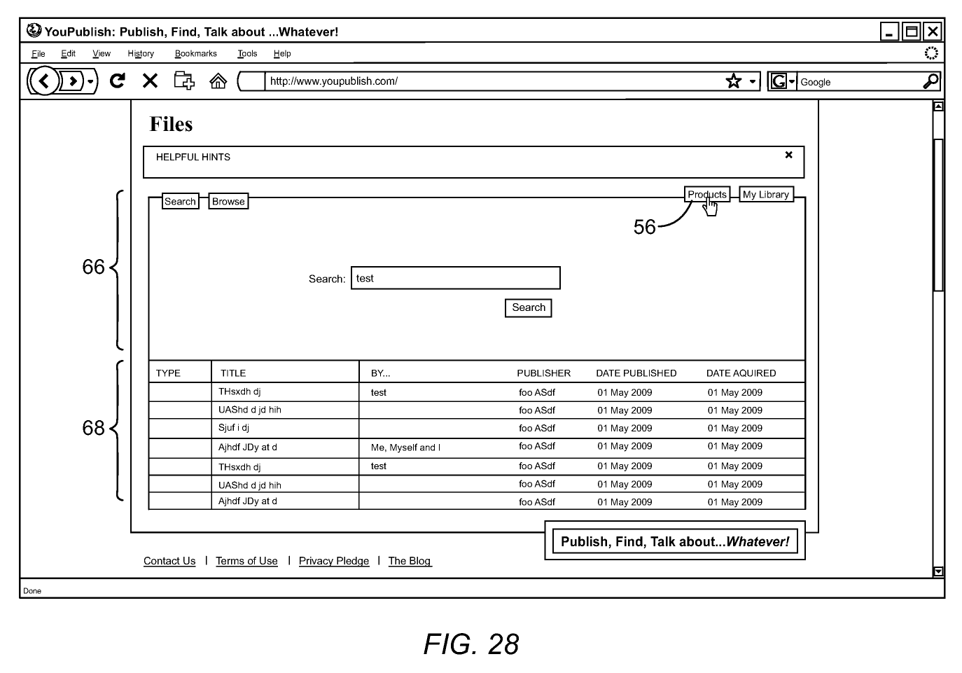

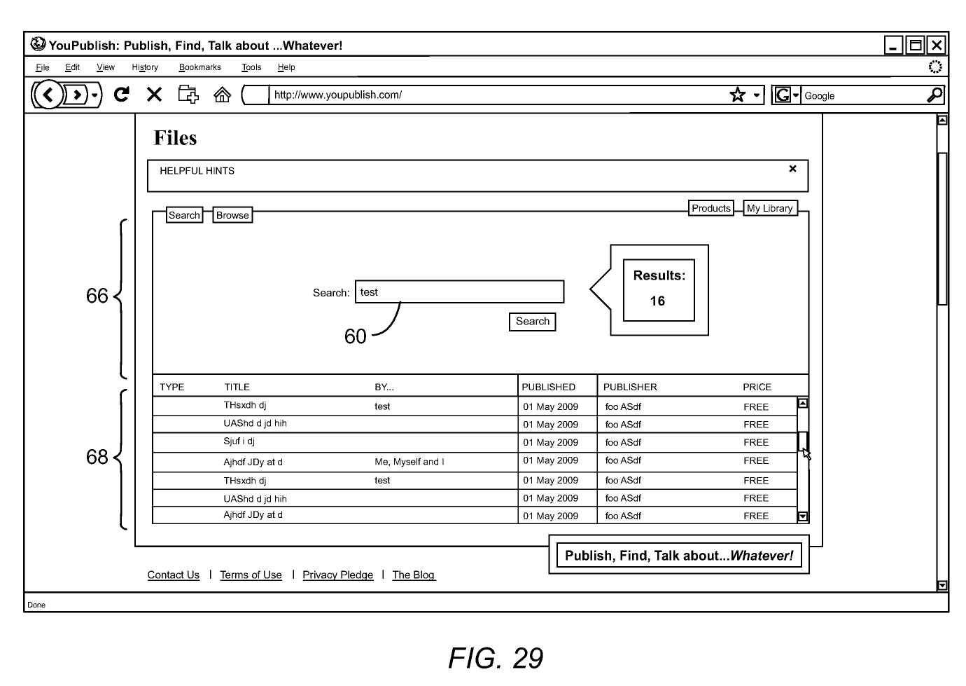

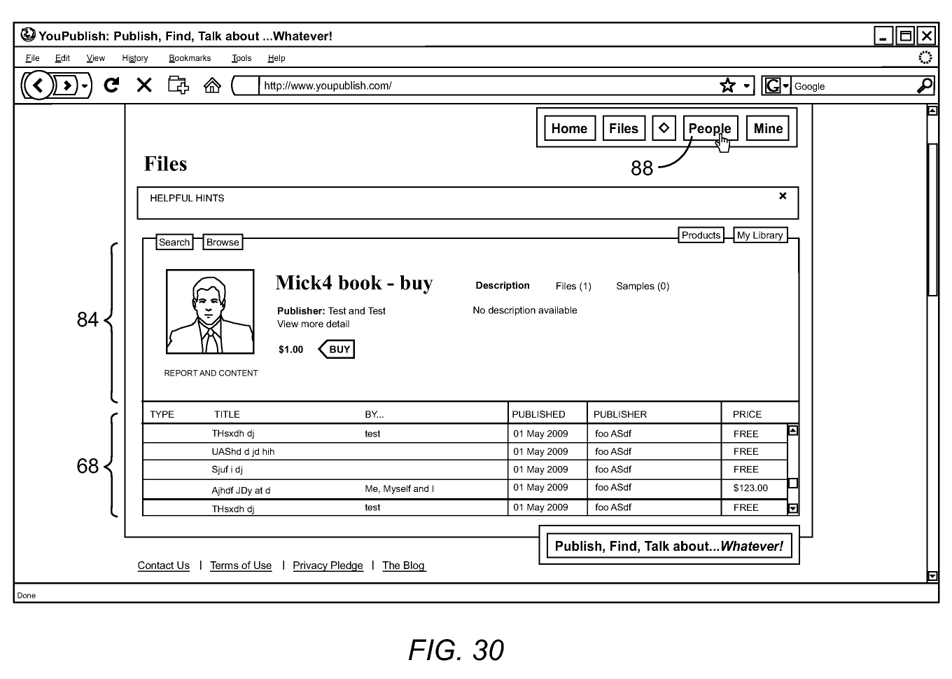

The products tab 56 may be selected as shown in FIG. 28, which may permit a product search to be performed through a user query transmitted to the server. In the example in FIG. 29, the user searched for the word “text” by inputting the search word in the text area 60, resulting in a display of 16 matches, the first of which appear in the list shown in the list presentation area 68. Again, a user may scroll down to see more results should there be more than were downloaded initially from the server. Items in this list may also be selected, as shown in FIG. 30 and described above.

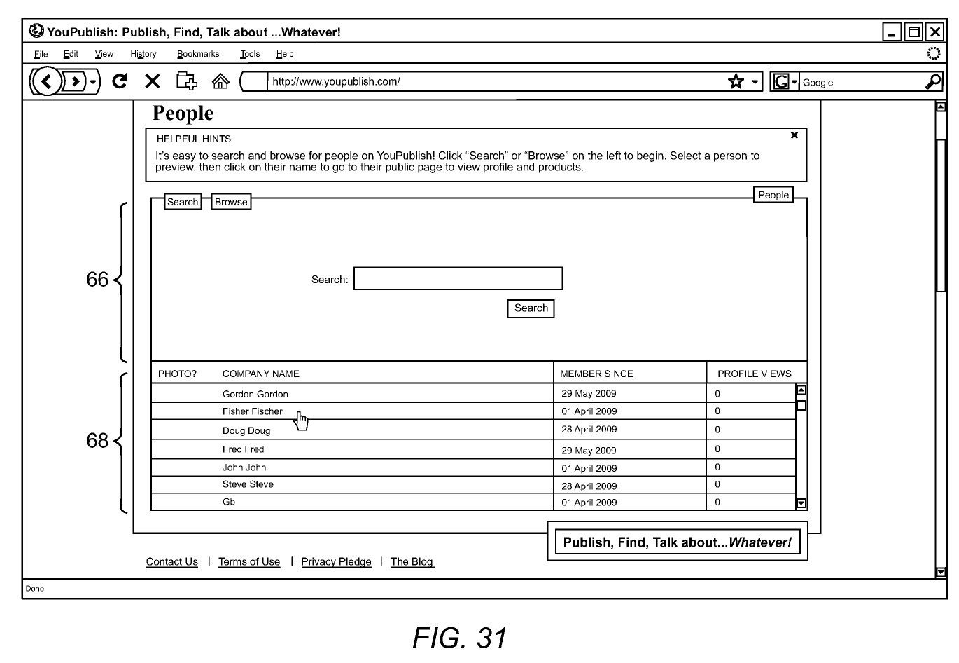

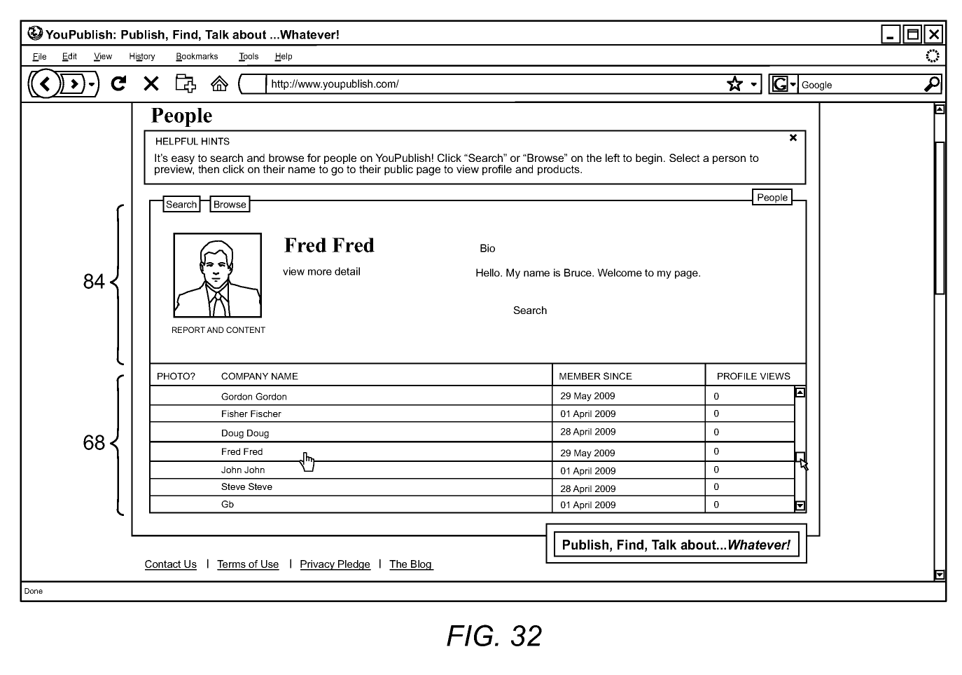

Now clicking on a people button 88 or people tab, as shown in FIG. 30, the same type of search and list display may occur for persons registered on the server, which display is shown in FIG. 31. Further information on a person may be retrieved from the server and displayed as in FIG. 32 by clicking on an item shown in a persons list displayed in the list presentation area 68.

A system may provide for displaying numerous search results of products or other items through an “infinite scroll” feature that conserves the download of items to be displayed in a list while permitting an expansion of a list through user action, for example by scrolling down to the bottom of a list of downloaded items. Through this functionality, pagination may be avoided. Additionally, list items may be selected or information related to the list items, such as product information in a list of products, may be previewed, both without leaving or losing a results list. This may conveniently be done in a user's web browser through downloaded executable code, thus avoiding the need to install a desktop application.

In one sense, a system and process is provided for displaying numerous search results (products) in a box (or widget) displayed in a user's web browser having an “infinite scroll” feature that allows scrolling the entire list of results without the need for pagination, no matter how long the list, including: having a database where files are stored, optionally having a database containing meta data about the files, a receiver of search inquiries from a user terminal over a network or the Internet, a matcher of those inquiries to the database of files and/or the database of meta data, an outputter providing information about those files matching the inquiry over a network or the Internet to a user, a renderer configured to display portion of those results in a user's web browser, a scrolling feature for scrolling the display results in which the page being displayed makes an asynchronous call to the server to access additional search results for display, the results of which are transmitted to the user's web browser for display, a displayer operable to preview (display) additional information about the search results (candidate products) without leaving the results list, a purchase selector for purchasing products “on-the-fly” from the results list or preview screen, again without leaving the results list, and an aggregator operable to aggregate multiple “on-the-fly” purchases into a single sale transaction without using a shopping cart and check out procedure or similar process.

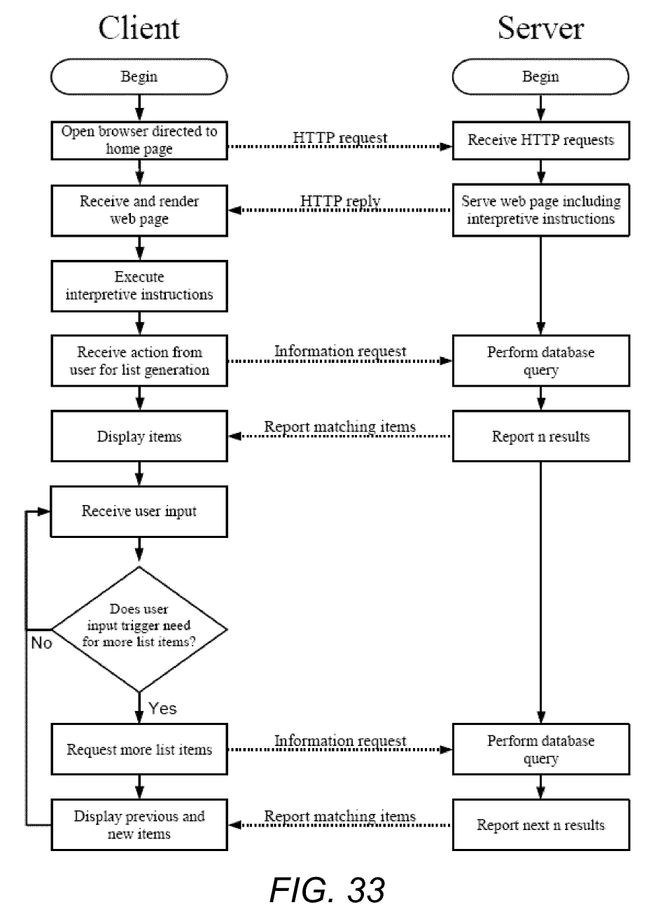

FIG. 33 illustrates steps that may occur in the continuous scrolling process/feature during scrolling of search results.

In alternatives of that system, the following may be provided: an uploader configured for multiple users to upload files directly to the database over the Internet using an upload link displayed in their browsers, an uploader configured to allow a user uploading a file to input meta data about the file, and a meta data display engine operable to display meta data about a file, such as price, creator, etc.

A system may include a transaction aggregator. Existing systems either require that all items to be purchased be collected in a shopping cart in preparation for the user to initiate a check out procedure, or record each individual sale as a separate transaction resulting in a separate credit card transaction for each item. For example, buying a large quantity of songs online in this manner can result in pages of $0.99 transactions on the user's credit card statement. One exemplary system may obtain authorization on the user's credit card for each item being purchased “on-the-fly”, but does not immediately charge the credit card. Transactions over a specified time period (for example, 48 hours) are then aggregated and charged to the credit card as a single transaction. If the aggregated charge is authorized, all previous authorizations that were obtained are canceled. If the aggregated charge is declined, the original authorizations may be processed. Only in the case of denial of the aggregated charge do the individual purchases show up as separate transactions.

One exemplary system herein allows search results to return any file type by providing a database for the files, and not merely an index into a directory of files or a results tabulation generated/indexed by a spider or bot. Such a database may include metadata allowing searches on a large number of criteria, such as creator name, date published, price, etc.

Embodiments of the invention thus utilize a system applicable to be used by content creators (“authors”) and online publishers (“publishers”) to distribute publications, products and files (for example, electronic books, papers, video music, art, graphics, photographs, software, or any other data or executable file) which they own, which are in the public domain, or to which they otherwise have publication rights for, which system also permits users of the system (“invitors”) to refer products or the service to other persons (“invitees”). The system tracks the referral, tracks the purchases of products (including electronic publications, copies of electronic publications on physical media, and other physical products) on the system by invitees and/or the sale of products by an invitee to other users of the system and paying an invitor a commission on those purchases, sales, or both.

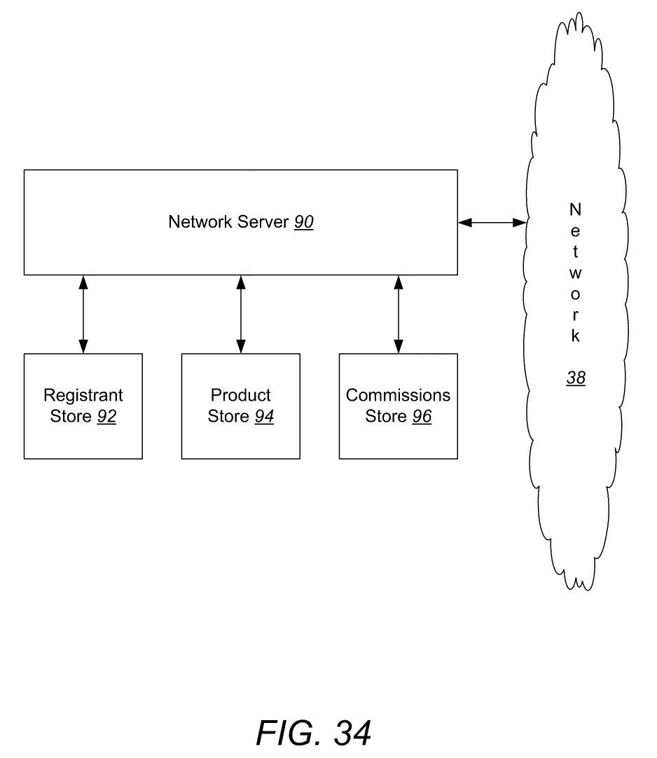

FIG. 34 illustrates components that may be included as part of the service system. A network server 90 connected to the network 38 contains programming (instructions, software or logic) to interact with persons through the network 38. The network server 90 could be a single processor implementing the functions disclosed herein, or the network server 90 could be a distributed one as desired. The operation of the network server 90 becomes clear through an understanding of the inventive concepts presented herein.

A registrant store 92 contains a number of profiles of registrants, which are persons who have registered with the system for the purpose of distributing, purchasing and/or receiving products. Each registrant profile contains information from which a registrant identifier can be determined. As three examples, a registrant identifier may simply be the name of a person, an e-mail address, or a unique sequence of characters or numbers associated with a person who has registered. A profile may include other registrant information including a mailing address, bank account routing number, credit card number, telephone number, other contact information, demographic information, or other information as desired.

A product store 94 contains product identifier information. In one example, that product information includes a downloadable electronic product, such as an electronic book, video, music file, or data file or executable code. However, it is sufficient that product identifier information contain only a reference to a product, electronic or not, for the purposes of the systems and methods disclosed herein.

A commission store 96 contains accounting records for the distribution of commissions, which records may be simply a list of product transactions with information needed to identify a commission, or commissions determined at or about the time of a transaction. These stores 92, 94, and 96 might be fashioned in any number of ways. For example, they might each be a separate database. Any store 92, 94, or 96 might be a single file. A common database might contain all three stores 92, 94, and 96, and further information as desired. Therefore, the description herein is merely exemplary and may be modified according to one of ordinary skill in the art.

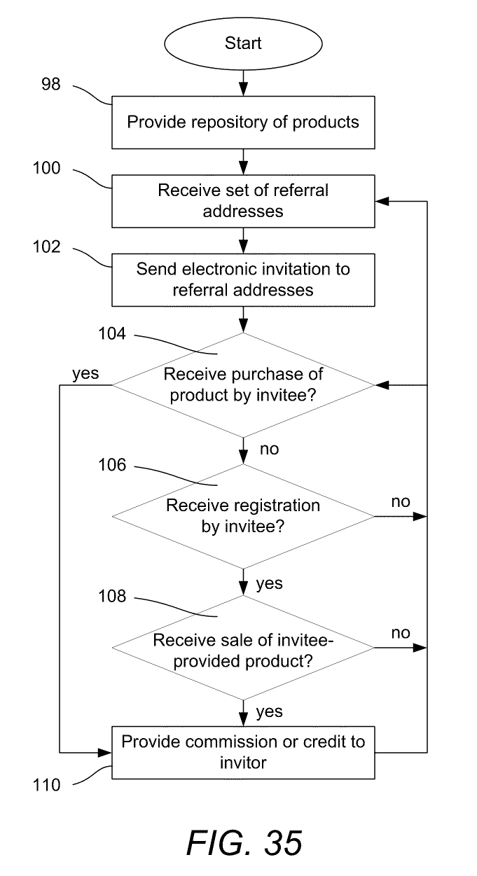

FIG. 35 illustrates a process that may occur in a method according to embodiments of the invention. According to the illustrated embodiment, execution begins at step 98, where a repository of products is provided for delivery of the products over a network and an associated delivery system. The repository of products may also or alternatively include a repository of product identifiers, where the product identifiers are used to identify products in a separate product repository. In the method, the system receives a set of one or more referral addresses from an invitor at step 100 and sends an electronic invitation to the set of referral addresses provided by the invitor at step 102. Each invitation may include a link or other element identifying one of the invitor and the electronic invitation. Each invitation also includes at least one of an invitation to view and purchase a product from the repository of products, an invitation to sell a product using the repository of products, or an invitation to become familiar with the system containing the repository of products and facilitating distribution of the products.

The invitations are presumably received by one or more recipients or invitees, who may choose to take some action in response to the invitation. The system thus may receive some action from a recipient of the invitation, such as after utilization of the link in the invitation. The received action may include a purchase of a product from the repository of products and/or a registration of the user to utilize the system. When the recipient registers with the system, the recipient may be able to utilize the system to sell his or her own products. The system may be configured to provide commissions, credits, or other benefits to the invitor upon revenue-generating acts taken by the recipient of the invitor's invitation, such as sales of products to the recipient or sales of products by the recipient.

Therefore, execution proceeds to decision block 104, where a determination is made whether the system received a purchase of a product by the invitee. If not, execution further proceeds to decision block 106, where a determination is made as to whether a registration of the recipient as a user of the system has been received. If not, execution loops back to either or both of step 100 for receipt of further referral addresses or decision block 104 to await a possible revenue-generating action by a recipient. If, however, a registration is received, and it is determined at decision block 106 that the recipient registered as a user of the system, execution proceeds to decision block 108, where the system determines whether the recipient has made a sale of a recipient product. If not, execution loops to step 100 or decision block 104. If, however, it was determined at decision block 104 that the recipient purchased a product and/or at decision block 108 that the recipient has made a sale of a recipient product, execution proceeds to step 110, where it a commission, credit, or other benefit is provided to the invitor based on the revenue-generating action by the recipient.

The products in the repository may include one or more computer files or other electronic publications that can be delivered over a network, including program files. When the system receives selection of the link in the electronic invitation (such as an e-mail) from the recipient, the system provides a web page associated with the link according to the nature of the invitation, such as a web page including one of information about a product from the repository of products and information regarding services provided in association with the repository of products.

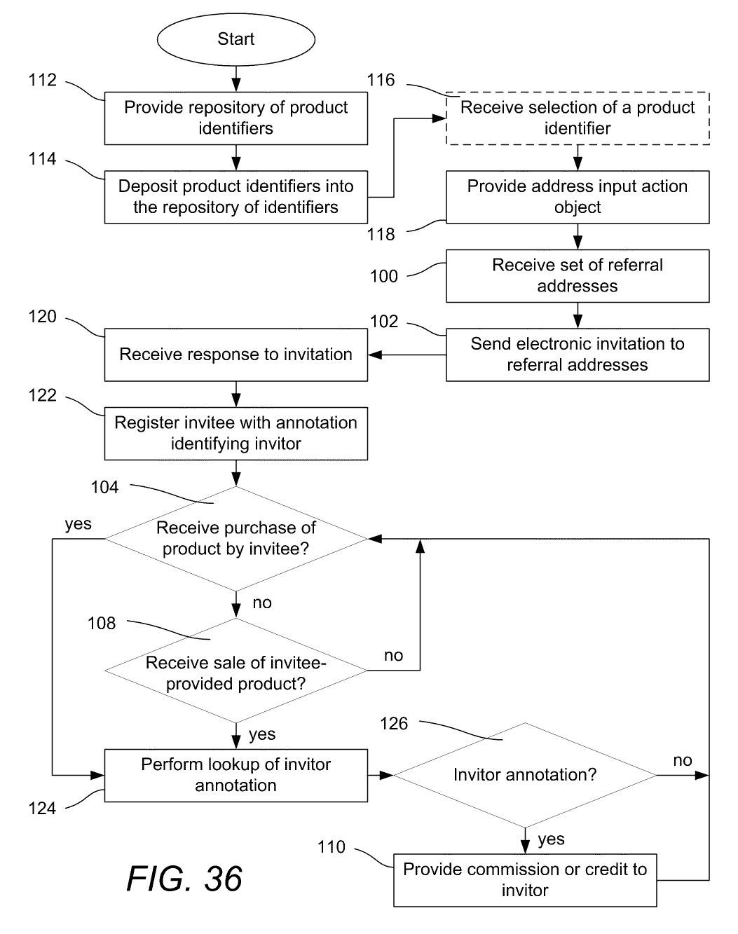

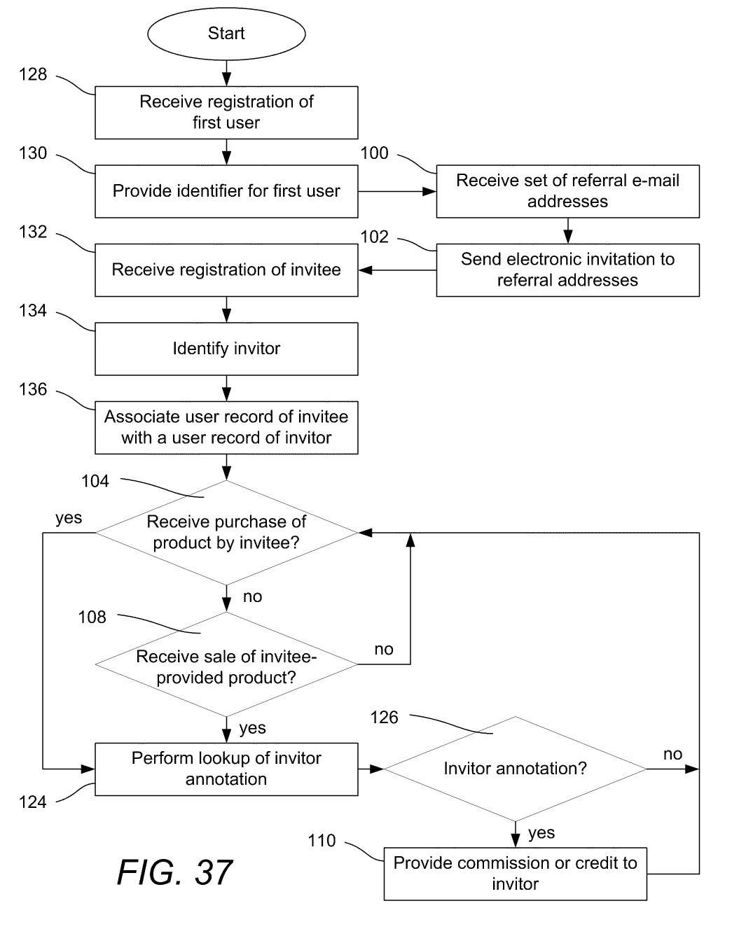

FIG. 36 illustrates an expanded method similar to the method illustrated in FIG. 36. This method includes step 112 where a repository of product identifiers is provided, and step 114, where one or more product identifiers is deposited into the product identifier repository. Execution then proceeds to optional step 116, where the system receives selection of a product identifier from the repository. As an example only, this may represent selection of a product on a web page generated by the system, or selection of a “refer” button associated with a product on the web page generated by the system. Execution then proceeds to step 118, where an address input action object is provided (e.g. to the web page after selection of the product or refer button). The address input action may be a pop-up element, a text box, some other active element within the web page, or any other object allowing the input of addresses for referral of the product (or other element of the system) associated with the product identifier.

Execution then proceeds to step 100, as with FIG. 35, where the system receives entry of a set of one or more addresses in connection with the selected product identifier. At step 102, an invitation is sent to the invitee or invitees, which may include an invitation to register with the system and/or purchase the referred product. The invitation may include a registrant identifier whereby an invitor registrant may be identified. At step 120, a response is received to the invitation, whereby execution proceeds to step 122, where the recipient is registered as a user of the system with an annotation identifying the invitor who made the original referral/invitation to the invitee. After registration by the invitee, both the invitee and the invitor have registration entries with the system.

The system may be configured to provide commissions, credits, or other benefits to the invitor upon revenue-generating actions, as discussed above, so execution may proceed to decision blocks 104 and/or 108, as discussed above, to determine whether the system has receiving a direction from the recipient to buy a product, or whether the system has received a direction from any party to buy a product provided to the system by the recipient. If so, execution proceeds to step 124, where the system performs a lookup of an invitor annotation of either the purchaser/recipient or the seller/recipient. At decision block 126, a determination is made as to whether an invitor annotation is present. If so, execution proceeds to step 110, for provision of the commission/credit/benefit to the invitor, as discussed above.

Therefore, in accordance with methods such as the method of FIG. 36, a repository of product identifiers is provided. Product identifiers may simply be identifiers that identify a product, by which other objects may reference a product. The method includes depositing product identifiers into the repository. In exemplary systems, a product identifier is a reference to a file maintained within a system including the repository of product identifiers. In other systems, a product identifier is a reference to a file maintained at another place on a network. In yet other systems, a product identifier is merely the identification of a product, such as the title of a book or video, or a catalog number. The depositing of the product identifier may ordinarily be by an author, publisher or creator. For example, an author may wish to provide an electronic book or paper to the repository for distribution. In other cases, the depositing of a product identifier is by another, for example the agent of an author/creator or the owner or manufacturer of a product.

Following the depositing of a product identifier, persons on the network may reference the network service. In this exemplary method, the network service is made available through HTTP and the Internet for the widest possible distribution. In other examples, a proprietary interface is used rather than a web browser. The referencing of the network service in this example is through a web page request, with the request referencing a product. That reference may be by a product identifier, but that is not necessary. In another example, a product reference may be made by requesting a generic page from the network service, by which the product reference may be automatically generated. In another example, a product reference is made through a search function, for example by searching for a particular author or subject. The network service may, but is not required to, identify a product of distribution; rather it is only needed that a product identifier result at some point.

It may be that a user wishes to refer a product to another person, e.g. to invite them to review or purchase a product. The service may generate a product presentation page that contains reference to a product and a corresponding address input action object. The address input action object may be, for example, a button on which the user may indicate that he wishes to forward a product to an address. It could take other forms, including but not limited to a text box or an active object that pops up when a cursor remains over a visual feature for a period of time.

Addresses, in the context of this disclosure, can be e-mail addresses, mailing addresses, or any other indication of a destination to which a referral may be sent. Activation of the address input action object may cause a new window, page or presentation to appear with a dialog instructing the user to enter a set of addresses. Activation of the address input action object may also simply present a code or identifier of the user as described below, which object may be inserted by the user into messages sent manually to potential referees/invitees. (It should be recognized that in some cases registration to a service will not be required. If so, a person being referred to a product available on a system may be termed a “referee.” If registration is not required and a referred person registers with the service, he may be viewed as becoming an “invitee” for purposes of distinguishing between an un-registered user and a registered user in systems where registration is not required only.) In another example, activation of the object starts an applet integrated with a user's e-mail client or address book, providing for the selection of persons rather than a more laborious entering of addresses.

The method then causes referring messages to be sent to the entered set of addresses. Each message contains a registrant identifier to identify the inviting party, such as an e-mail address. In the case of e-mail addresses provided to the system by the invitor, a system can be programmed to send out an e-mail invitation on that invitor's behalf with or without a personalized message. That registrant identifier could be an identifier from the registrant store, or it could be a code that correlates to the registrant in some other way. The message or e-mail may include a link which will uniquely identify which invitation the invitee is responding to. In one example, the addresses are e-mail addresses, the referring messages are e-mail messages, and a URL is inserted into each e-mail message that includes the registrant identifier or an invitation identifier. Note that other information may be included in a referring message, including a description of a referred product and the identity of the inviting party.

Upon receiving a referring message, a referee/invitee may wish to explore the possibility of purchasing the referred product or service, or the service system in general. In one example, the referring message contains a link that can be clicked on by the referee, as described above. Clicking on the link opens a web page to the service, such as to the referred product. The link may be annotated or embedded with a registrant identifier, and the page being served may indicate that a cookie should be placed on the referee's computer should he return at a later time. In another example, the service may present a location for the entry of a registrant identifier, which may or may not be required to review or purchase a referred product.

In some alternatives it may be that a user (invitor) wishes to introduce/refer to the referee/invitee the invitor's publications/products generally; wishes to introduce/refer the invitee to the system/service as a source/marketplace for content and products generally; and/or wishes to introduce/refer the invitee to use the service/system to publish his/her own content/products to make available for distribution and/or sale to other users. Regardless, an invitation message and/or a landing or destination page may be constructed accordingly.

The initial or further contact of the referee with the service may suggest or initiate a registration procedure, although that is not required in all instances. It may be desired to require the registration of a referee before a purchase can be made, although a service may permit a purchase or other access to the service without a registration. A registrant identifier may be persistent, and thus a later registration will not necessarily destroy the relationship between the inviting user and the referee. If a registration is made by the referee/invitee, the service may record that relationship for other purposes, some of which are made apparent herein.

A referee/invitee may wish to acquire a referred product, and may provide the selection of a product and/or a product identifier. When a product identifier has been received or generated, the service may optionally display a representation of the corresponding product. That representation may be as simple as a title or catalog number, or may be rich in content containing samples, pictures, portraits or other related information such as prices, number of pages, file size, time to download, etc.

If the referee/invitee indicates that a purchase or transaction is wanted, he or she may send and the service may receive a direction of that transaction. The service may consult the registrant store, or other location, of existing relationships to which the referee/invitee is listed, which relationship record may be referred to herein as an annotation. Alternatively, the service may note an invitor/referee relationship through a cookie or information embedded in a URL, or through the entry by the invitee of an e-mail address previously entered/provided by the invitor. If an e-mail address is used, then a determination is made as to which invitor is to receive credit, such as the most recent person to provide the address, or a screen to the registering user asking for the selection of an invitor sponsor, or simply by sharing credit among several invitors. If an annotation exists, the service may apply a commission or credit to the inviting party by placing an entry in the commissions store, generally at the time the transaction is made. Note that annotations herein might be simply a relationship between two parties for all products available through the service. However annotations may also be directed to individual products or groups of products, and purchases outside the group may not generate a commission.

Periodically or at certain intervals, the system may calculate and/or pay out, or cause a calculation/payout to occur, regarding commissions/credits/benefits to invitors based on purchases and/or sales by invitees. The calculation may be carried out through registration information contained in the registrant store. The system may further provide the calculated commission information by way of hard copy, check print run, or electronic data storage or transfer to facilitate payment. That payment may be by electronic or paper payment, through credits applicable to future purchases through the service, or other thing of value.

In one specific embodiment of a method for storage and distribution of electronic publications by content creators and online publishers with referral-based commissions, the system receives a set of one or more referral addresses from an invitor and sends an electronic invitation (e.g. e-mail invitation) to the set of referral addresses provided by the invitor. The invitation includes an identifying link along with an invitation to a recipient to use the system to sell the recipient's products using the system. When the recipient registers as a seller of products, the system associates the registration of the recipient with the invitor.

The system receives, from the recipient, an upload of a recipient product into a repository of products and makes the recipient product available for sale. The system then receives a request (such as from a third party) to purchase the recipient product and payment for the request and utilizes the association of the recipient and the invitor to provide one of a commission, a credit, or other item of value/benefit to the invitor for the purchase of the recipient product.

According to another embodiment, as illustrated in FIG. 36, a method for storage and distribution of electronic publications by content creators and online publishers with referral-based commissions is provided in association with a system for storage and distribution of electronic publications from a repository of products over a network. The system receives a first registration of a user of the system at step 128 and provides an identifier for the registered user at step 130. The system then receives a set of one or more referral e-mail addresses from the registered user at step 100, as has been discussed above, wherein the registered user becomes an invitor. Each e-mail address is associated with an invitee being invited to use the system by the invitor.

The system sends an electronic invitation to the set of referral e-mail addresses provided by the invitor at step 102, as previously discussed, the invitation being for the invitees to use the system. The system receives a second registration at step 132, this registration being of one of the invitees to use the system. Upon receiving the second registration, the system identifies the invitor at step 134 and associates a user record of the invitee with a user record of the invitor at step 136.

The system may use any method to identify the invitor when the invitee registers. For example, the system may associate the invitor and invitee based on an invitee e-mail address used for registration of the invitee that matches the address provided by the invitor. As another example, the system may associate the invitor and invitee using a link provided in the electronic invitation and used by the invitee to access the system. Alternatively, the system may associate the invitor and invitee based on an input of the invitor's identifier or some other information input by the invitee upon registration. The system the receives a purchase of a product by the invitee and/or a purchase by a third party of a product sold by the invitee, and provides a commission, credit, or other benefit to the invitor in similar fashion to that discussed with respect to FIG. 36 (decision block 104 through step 110).

Thus, one method in accordance with embodiments of the invention includes steps of receiving registration of a user of the system, providing an identifier for the registered user, and identifying the registered user, such as through a log in procedure. The method also includes steps of receiving a set of e-mail addresses from the registered user and sending an invitation to the e-mail addresses. The system receives a registration from the invitee, and identifies the invitor based on one of the invitee's e-mail address used for registration, the link used by the invitee to access the site, and/or an input of the invitor's user ID by the invitee, whereupon the system associates the invitor's user ID or user record with the user record of the registered invitee.

In at least a first version of this method, the method further includes receiving a direction of a product to purchase from the registered invitee. In connection with the purchase order, the system performs a lookup of the invitor annotation of the registered invitee making the purchase, and if an invitor is identified, applies a commission, credit, or other benefit to the invitor of the purchaser.

In at least a second version of this method (the features of which may optionally be combined with the features of the first version), the method further includes receiving an upload of one or more files from the registered invitee. In connection with the upload from the registered invitee, the system makes an annotation of the user record of the user uploading the file or files, the annotation optionally including an instruction to apply an invitor commission, credit, or other benefit upon sales of the uploaded file or files. When the system receives a purchase order from another user for the any of the uploaded files, it performs a lookup of the user who uploaded the file being purchased. The system then performs a lookup of any invitor annotation of the registered invitee who posted the file. If an invitor is identified, the system applies a commission, credit, or other benefit to the invitor of the purchaser.

In either of the above two versions, the system can be configured to receive payment information from the invitor and to format a set of payment instructions that can be printed or that can be electronically transmitted to a financial institution to make payment. In addition, in either of the above two versions, the system can be provided with an ability or screen (e.g. web page screen) to track the status of the invitee, thus allowing the invitor to know if an invitee has registered with the system. In addition, any of the above systems/methods can be provided with a screen to show the commissions owing to the invitor in respect of the invitees, either collectively, individually, or on a product-by-product basis.

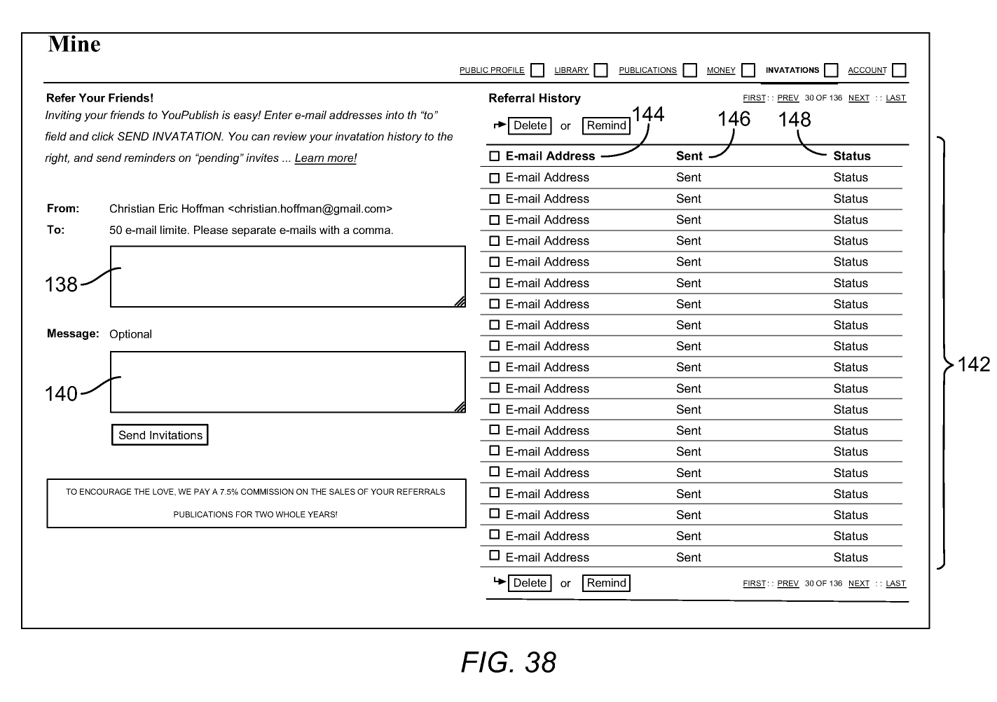

Another example may be illustrated with respect to FIGS. 38-44. This exemplary system maintains a database of files that can be downloaded and/or viewed for a fee, which can be a fee per individual file, per product, or per a group of files or products. A related system maintains a database of products that can be purchased from a web site. Within the exemplary system, an input screen, as illustrated in FIG. 38, may be provided where a user can input e-mail addresses of their contacts or import a list of such e-mail addresses, such as in a comma-delineated file. The contacts input by the user are those to which a referral e-mail is or may be desired to be sent. By way of example only, the input screen of FIG. 38 includes an input box 138 for inputting e-mail addresses, and a custom message box 140 for inputting a custom message to be included with an invitation e-mail.

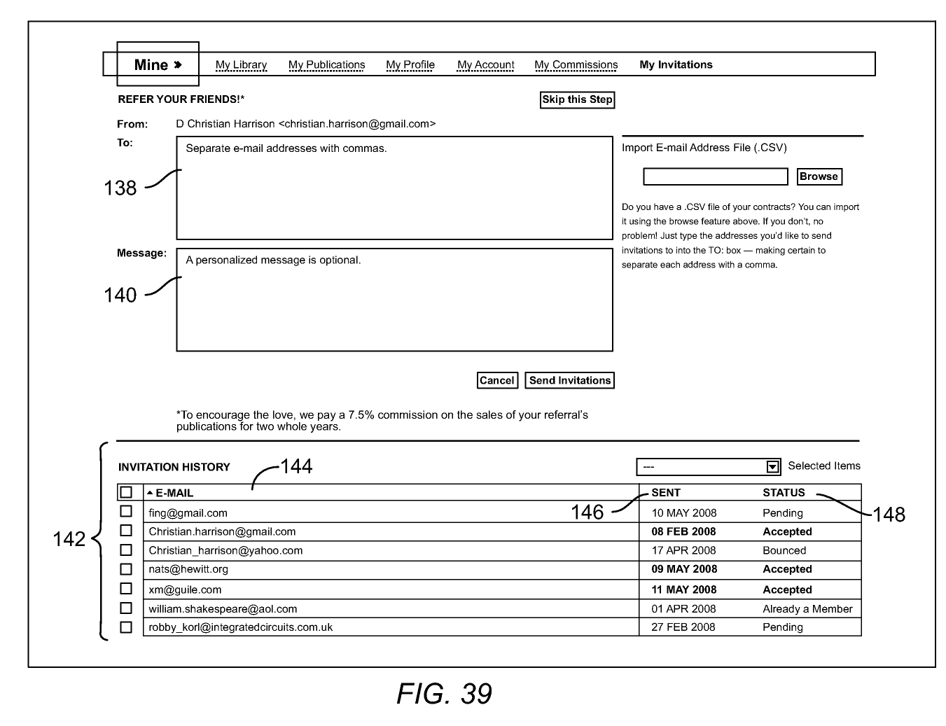

To assist the user in tracking the user's referrals, the input screen of FIG. 38 also includes a referral history area 142. The referral history area 142 may include an e-mail address list 144, a date sent column 146, and a status column. These may allow a user to view and sort his or her previously-sent referrals, and may allow the user to view the status of the referral invitations (sent, invitation viewed, site viewed, invitee registered, already a member, etc.). The input screen may also allow the user to send a reminder e-mail to a recipient of a previously-sent invitation by using the referral history area 142 and one or more associated buttons or features. FIG. 39 provides an alternate input screen view showing these features.

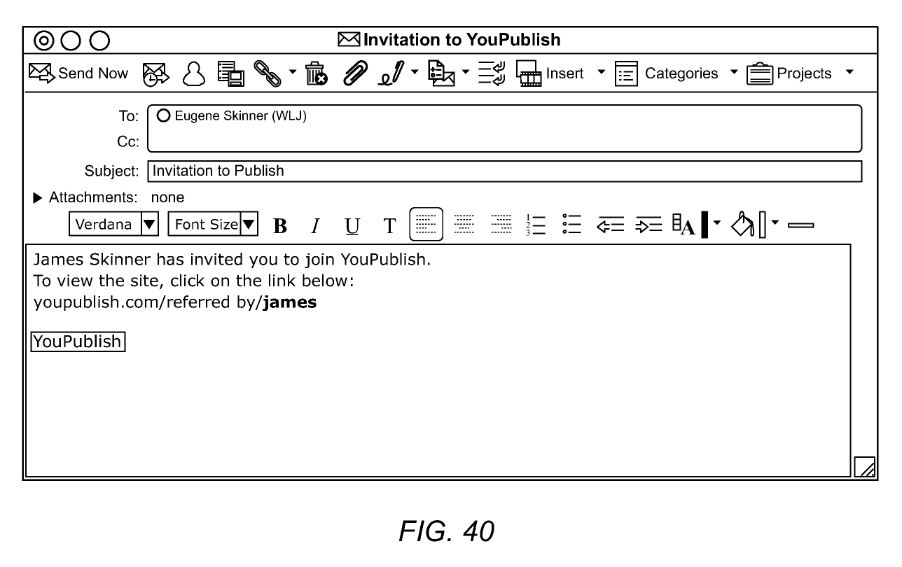

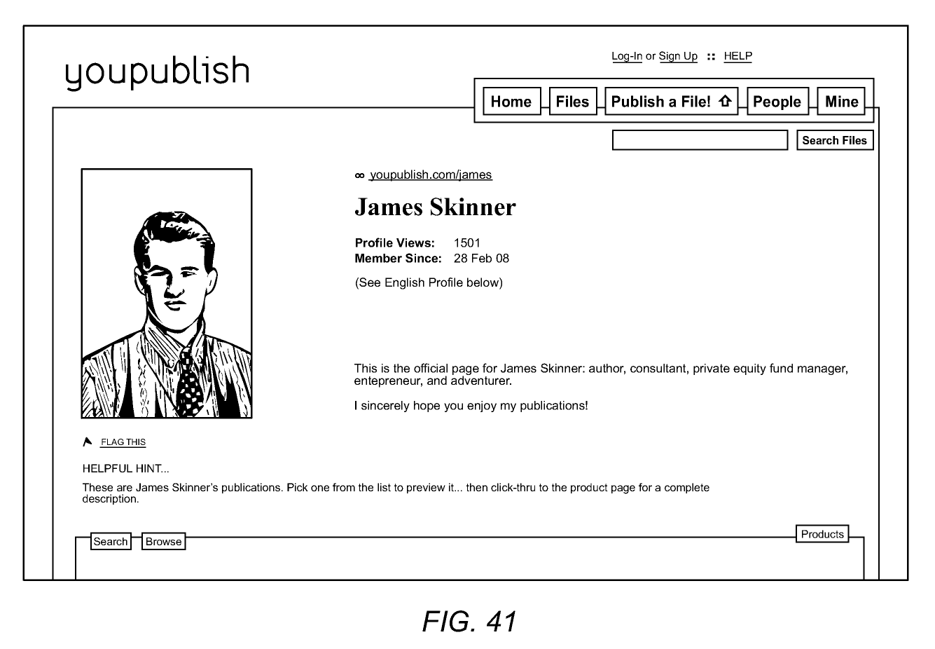

After the user inputs one or more e-mail addresses for new referral purposes, the system configures an e-mail to be sent to each of the input addresses with a link to one of the pages in the website, such as the page displaying the files posted by the referring user who provided the e-mail address for the invite. FIG. 40 shows an example of what such an e-mail may look like when received. The link may contain an identifier which identifies the user who input the e-mail address, and this information may be stored, such as in a cookie, when a user accesses the site using the link provided in the e-mail configured above. FIG. 41 shows an example of a screen that may be provided by the web site when the user accesses the site using the link provided in the e-mail. The screen includes a display of information regarding the user making the introduction to the site (such as from a profile of the user). A bottom portion of the screen (not shown) may contain a list of files or other products posted by the user making the referral and/or recommended by the user making the referral.

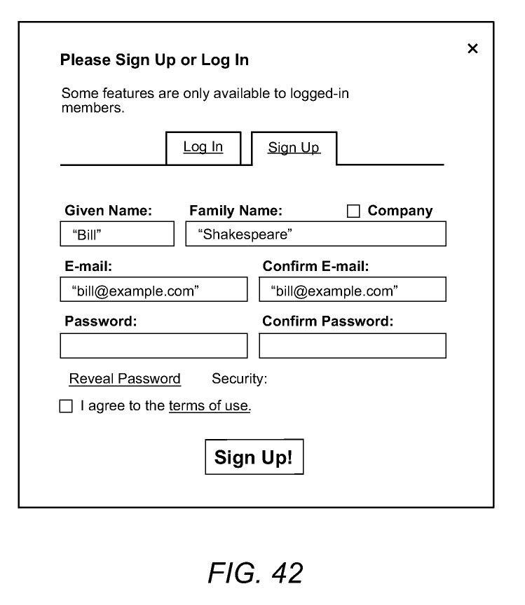

If the referred visitor chooses to register as a site member, he or she may do so by accessing a link displayed either in the e-mail or in one of the pages on the web site. FIG. 42 shows a display that may be shown when the visitor elects to register as a site member. Alternatively, the visitor might choose to re-visit the site at a later date and might register at that time (with or without re-selecting the link provided in the invitation e-mail).

If the user accessing the site from the link registers as a site member during the session for which the stored referral information is active, the identifier for the user who provided the e-mail address is then included in the user database indicating that this person was referred by the person who provided the e-mail address. Alternatively, if the stored referral information is no longer active or if the referred user elects to register from a different computer or device, the referral information may be inferred from an e-mail address entered by the referred user (e.g. by a match to information regarding past invitations stored in the system).

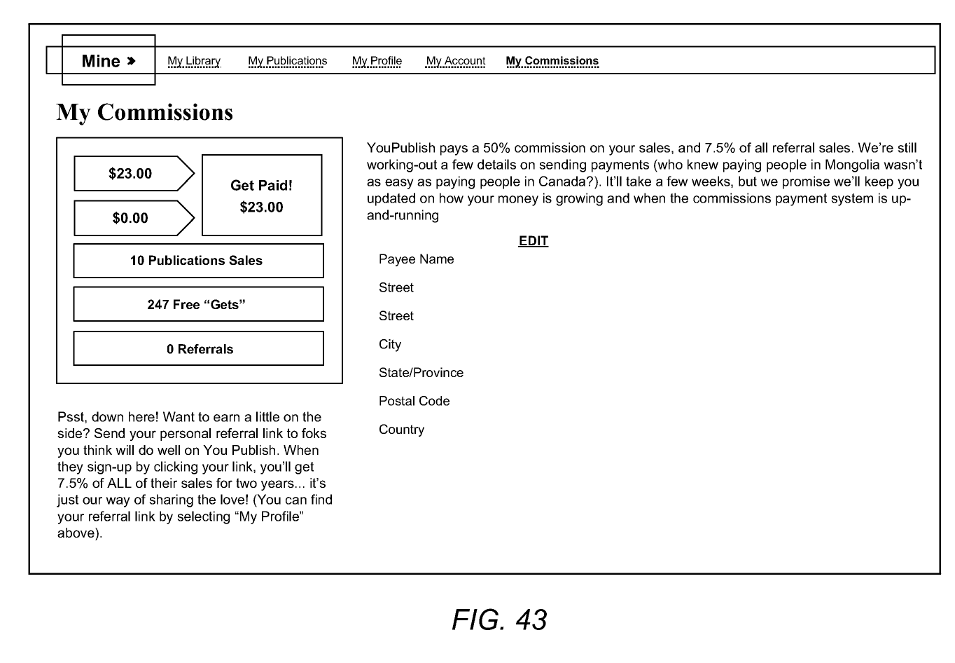

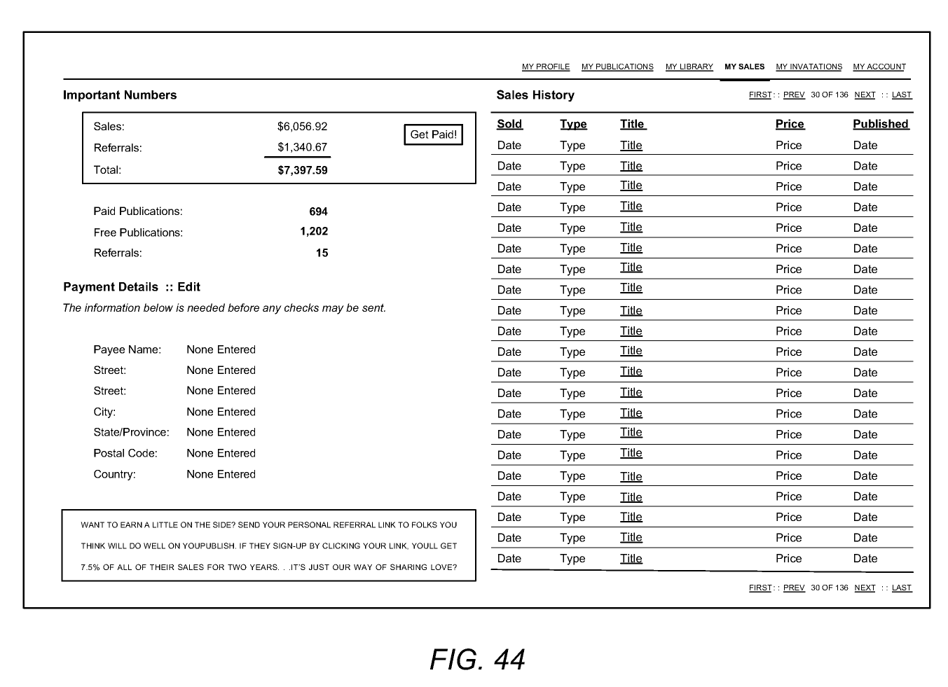

Then, whenever the new user purchases products or files on the site, a percentage or portion of that sale may be credited to the account of the user who provided the e-mail address or referred the new user. In an alternative example, a portion of every sale is provided to the invitor of the invitee who is the poster of the products or files, the poster being the person or entity that provided or uploads the products and/or files and was invited to register with the service by that invitor. The amount credited may either be paid to the user, such as through a check or bank transfer, may be credited to an account which can be drawn on using a debit or credit card, or may be used as credit for shopping on the site. FIGS. 43 and 44 provide sample reports that may be provided to users showing commissions or other benefits generated based on the user's referrals history.

An alternative method of tracking the referred user is to store the e-mail address input into the invite screen, and credit the user who provides that address as the referring member whenever a user registers on the site using that e-mail address. The above system can further provide an input screen for adding a custom message. The above system can further provide a screen for showing the status of invitations made so far, so that the user can send additional notices to users who did not respond to the first invitation.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A non-transitory, tangible computer-readable medium storing computer instructions for causing a computer to execute a method for storage and distribution of electronic publications by content creators and online publishers with referral-based commissions, the method comprising:
providing a repository of products for delivery over a network;
receiving a set of one or more referral addresses from an invitor;
sending an electronic invitation to the set of referral addresses provided by the invitor, the invitation comprising a) a link identifying one of the invitor and the electronic invitation and b) at least one of:
an invitation to view and purchase a product from the repository of products; and
an invitation to sell a product using the repository of products;
at least one of:
receiving, from a recipient of the invitation, a purchase of a product from the repository of products after utilization by the recipient of the link; and
receiving a registration of the recipient as a seller of products after utilization by the recipient of the link, followed by a sale of a product provided by the recipient to the repository of products; and
utilizing information provided by the use of the link to apply one of a commission and a credit to the invitor for the purchase or sale.

2. A computer-readable medium as recited in claim 1, wherein each of the products in the repository comprises one or more computer files.

3. A computer-readable medium as recited in claim 1, the method further comprising:
receiving selection of the link in the electronic invitation from the recipient;
providing a web page associated with the link, the web page including one of information about a product from the repository of products and information regarding services provided in association with the repository of products.

4. A computer-readable medium as recited in claim 3, wherein the information regarding services provided in association with the repository of products comprises information explaining how the recipient can upload products to the repository of products and sell the uploaded products to others from the repository of products.

5. A computer-readable medium as recited in claim 1, wherein the electronic invitation comprises an e-mail sent over the network.

6. A computer-readable medium as recited in claim 1, the method further comprising providing a representation of a product to the recipient over the network.

7. A computer-readable medium as recited in claim 1, wherein the electronic invitation comprises a referral of a product to the recipient.

8. A computer-readable medium as recited in claim 1, wherein the electronic invitation comprises a referral of a system for distributing products over the network from the product repository.

9. A computer-readable medium as recited in claim 1, the method further comprising:
receiving selection of an address input action object from the invitor; and
providing the invitor with a mechanism for inputting the set of referral addresses.

10. A computer-readable medium as recited in claim 9, wherein the address input action object comprises an object selected from the group consisting of:
a button;
a text box; and
an active object configured to activate when a cursor remains over a feature for a selected length of time.

11. A computer-readable medium as recited in claim 1, the method further comprising providing a landing web page corresponding to use of the link.

12. A computer-readable medium as recited in claim 1, the method further comprising associating a registration of the recipient with the invitor, whereby sales by the recipient and purchases by the recipient generate one of a commission and a credit for a period of time.

13. A non-transitory, tangible computer-readable medium storing computer instructions for causing a computer to execute a method for storage and distribution of electronic publications by content creators and online publishers with referral-based commissions, the method comprising:
providing a repository of products for delivery over a network;
receiving a set of one or more referral addresses from an invitor;
sending an electronic invitation to the set of referral addresses provided by the invitor, the invitation comprising:
a link identifying one of the invitor and the electronic invitation; and
an invitation to use a system including the repository of products;
receiving a registration of a recipient of the invitation as a seller of products after utilization by the recipient of the link;
associating the registration of the recipient with the invitor;
receiving an upload of a recipient product into the repository of products from the recipient;
receiving a request to purchase the recipient product and payment for the request; and
utilizing the association of the recipient and the invitor to provide one of a commission and a credit to the invitor for the purchase of the recipient product.

14. A computer-readable medium as recited in claim 13, the method further comprising:
receiving a selection of the link by the recipient; and
providing a landing web page corresponding to use of the link.

15. A computer-readable medium as recited in claim 14, wherein receiving the selection of the link comprises receiving information identifying the invitor.

16. A computer-readable medium as recited in claim 13, wherein associating the registration of the recipient with the invitor comprises providing an annotation on a record of the recipient identifying the invitor.

17. A computer-readable medium as recited in claim 16, wherein in connection with sales of recipient products, a lookup is performed for the annotation, and commissions are recorded to the invitor for the sales of recipient products.

18. A computer-readable medium as recited in claim 16, the method further comprising providing the invitor with tracking information regarding the recipient, the tracking information comprising one of:
information regarding whether the recipient has registered as a seller of products;
summary information regarding commission-generating sales by the recipient; and
detailed information regarding commission-generating sales by the recipient.

19. A non-transitory, tangible computer-readable medium storing computer instructions for causing a computer to execute a method for storage and distribution of electronic publications by content creators and online publishers with referral-based commissions, the method comprising:
providing a system for storage and distribution of electronic publications from a repository of products over a network;
receiving a first registration of a user of the system;
providing an identifier for the registered user;
receiving a set of one or more referral e-mail addresses from the registered user, wherein the registered user becomes an invitor and wherein each e-mail address is associated with an invitee;
sending an electronic invitation to the set of referral e-mail addresses provided by the invitor for the invitees to use the system;
receiving a second registration of one invitee to use the system;
identifying the invitor upon registration of the invitee based on one of:
an invitee e-mail address used for registration of the invitee that matches the address of the invitation;
a link provided in the electronic invitation and used by the invitee to access the system; and
an input of the invitor's identifier by the invitee;
associating a user record of the invitor with a user record of the invitee as invitor/invitee;
receiving a sale of a product from the repository of products associated with the invitee; and
applying a commission or credit to the invitor for the sale of the product.

20. A computer-readable medium as recited in claim 19, wherein the sale of the product comprises one of:
receiving, from the invitee, a direction to purchase the product from the repository of products; and
receiving, from a third party, a direction to purchase the product from the repository of products, wherein the product is a product uploaded to the repository of products by the invitee.
